(19) United States
(12) Patent Application Publication
(10) Pub. No.: US 2004/0064326 A1
(43) Pub. Date: Apr. 1, 2004

(54) System and method for processing mail including pre-sorted mail, and a smart mail box adaptable for use with the system and method

(75) Inventor: Nino R. Vaghi, McLean, VA (US)

Correspondence Address: FLESHNER & KIM, LLP, P.O. BOX 221200, CHANTILLY, VA, 20153, US

(73) Assignee: Vaghi Family Intellectual Properties, LLC

(21) Appl. No.: 10/254,998

(22) Filed: Sep. 26, 2002

(51) Int. Cl. G06F 17/60

(52) U.S. Cl. 705/1; 705/406

(57) ABSTRACT

A method for processing mail provides a pre-sorting service to a market which is not recognized by any public or private entity in the mailing and shipping industry. This market includes businesses and/or individuals who alone are unable to satisfy the minimum requirements of a postal service for pre-sort mail. The method in includes providing a mail box for collecting pre-sort mail in an office building, business area, or another publicly accessible venue, collecting mail from the mail box, and then combining it into pre-sorted bundles which satisfy postal service requirements for pre-sort mail. The bundles are then submitted to a post office to thereby realize a profit. The invention is also a smart mail box which includes a processor for performing at least one of a variety of mail-related and communications functions. To aid the customer, the box may include a display. A remotely located management center may monitor the status of the box to provide enhanced services to consumers. The invention is also a mail box which expands its capacity to accommodate more mail when a detector detects that the mail box has reached a predetermined state of fullness.

### BACKGROUND OF THE INVENTION

1. Field of the Invention

This invention generally relates to processing mail, and more particularly to a system and method for processing mail including pre-sorted mail. The invention also relates to a smart mail box which may be adapted to perform one or more mail-related applications, at least one of which is particularly useful within the system and method of the invention.

2. Description of the Related Art

The rates for mailing letters, flats, and other items through the U.S. Postal Service are increasing faster than ever before. The Postal Service attributes the rise in rates to the costs of doing business. For example, on its website (www.usps.com, dated Aug. 6, 2002), the Postal Service offered the following explanation to justify its most recent rise in postage rates:

Postal costs go up like those of any other business or household. In fact, increases in costs for fuel and health benefits greatly affect the Postal Service. In addition, we are adding 1.6 million deliveries each year. The Postal Service receives no tax dollars for operations and relies solely on the sale of its products and services to cover its operating costs.

In order to improve the efficiency of processing the mail, the Postal Service offers a special service called “pre-sort mail.” This service allows a participating post office to accept bulk shipments of first-class mail which have been pre-sorted based on zip-code. Pre-sorted mail can be processed faster and more cost efficiently than other forms of mail and therefore has proven to be highly desirable. In order to encourage the public to use this service, a special reduced rate is offered for presorted mail.

The introduction of pre-sort postage rates generated a new type of business in the private sector. This business, implemented by so-called “pre-sort” houses, mediates between the Postal Service and customers who have large volumes of mail, i.e., those who require bulk-mail services. Pre-sort houses commonly use automated mail-processing equipment to pre-sort hundreds of thousands of letters on a daily basis. These letters are then delivered to a post office designated to receive pre-sorted mail, and the pre-sort house receives money in return based on the reduced pre-sort rate.

While pre-sort houses offer an important service to the public, their business practices are less than desirable in at least one respect. For economic reasons, conventional pre-sort houses have restricted the scope of their services to customers who have large amounts of out-going mail. A large segment of the population has therefore been denied this service. This segment includes individuals and small businesses who are unable to individually meet Postal Service requirements for presort mail. This may arise in the following situation.

In order to receive the reduced rates offered by the Postal Service, pre-sort mail must be delivered in bundles containing a minimum number of letters. Under current Postal Service guidelines, bundles of 500 letters or more are required. Further, only letters and flats have been considered for this service. In view of these and other requirements relating, for example, to the size and weight of the mail, conventional pre-sort houses have found that it is economical for them to only serve customers who can meet Postal Service requirements on an individual basis. Businesses who have more modest mailing needs (e.g., those who are unable to meet the minimum requirements for pre-sort mail) have been overlooked and thus denied the opportunity to benefit from the reduced pre-sort rates offered by the Postal Service.

The present state of the mailing industry is deficient in at least one additional respect. Conventional mail processing methods typically begin with collection of the mail from mail boxes located throughout a particular region. Collection occurs at predetermined times and sometimes multiple times per day. In highly populated areas, the mail boxes may become full prior to their pick-up times. When this happens, customers must either find other mail boxes which are not full or wait to mail their cards and letters another day. Unfortunately, the Postal Service will not become aware of this condition until a courier actually arrives to pick up the mail.

In view of the foregoing discussion, it is clear that a need exists for a system and method which provides pre-sort mailing services to customers who cannot satisfy the minimum requirements of the U.S. Postal Service for pre-sort mail. A need also exists for a system and method which allows public and/or private organizations to monitor the status of mail boxes in a geographic area, in order to enhance customer service while simultaneously increasing mail processing efficiency.

### SUMMARY OF THE INVENTION

It is one object of the present invention to provide a pre-sort mailing service in a market which has not been recognized by conventional pre-sort houses or any other public or private entity within the mailing and shipping industry.

It is another object of the present invention to achieve the aforementioned object by providing a system and method which provides pre-sort mailing services to customers who cannot satisfy the minimum requirements of the Postal Service for pre-sort mail.

It is another object of the present invention to achieve the aforementioned object by combining mail from multiple customers to form bundles which satisfy Postal Service requirements for pre-sort mail, thereby allowing customers with more modest mailing needs who are overlooked by conventional pre-sort houses to receive reduced pre-sort rates while simultaneously creating a new type of business service.

It is another object of the present invention to provide a system and method which allows individuals to benefit from pre-sort mailing rates.

It is another object of the present invention to achieve the aforementioned objects by providing a mail box, preferably in an office building, business area and/or other publicly accessible venue, dedicated to collecting pre-sort mail from small businesses and individuals who cannot meet the minimum requirements of the Postal Service for pre-sort mail.

It is another object of the present invention to provide a system and method which remotely monitors the status of a mail box which may or may not be dedicated to receiving pre-sort mail.

It is another object of the present invention to achieve the aforementioned object incorporating a processor into the mail box for controlling at least one function of the mail box.

It is another object of the present invention to provide a mail box having a communications unit which transmits status and/or performance information to a remotely located manager or computer system.

It is another object of the present invention to provide a mail box of the aforementioned type which receives information from the remotely located manager or computer system for activating or de-activating one or more functions of the mail box.

It is another object of the present invention to provide a mail box having a communications unit which allows customers to talk to a remotely located customer service representative in order to obtain information that will satisfy mailing needs of the customers.

It is another object of the present invention to provide a mail box whose capacity for receiving mail expands when a detector detects that the mail box has reached a predetermined level of fullness.

It is another object of the present invention to provide a mail box equipped with a scale for determining a quantity of mail located within the box.

It is another object of the present invention to provide a mail box equipped with a display for displaying information to customers relating to a mailing service or function performed by the mail box.

It is another object of the present invention to provide a mail box having an electronic security device which controls access to the mail box based on customer identification information.

It is another object of the present invention to provide a mail box having a processor for communicating information over the internet.

It is another object of the present invention to provide a mail box having a processor for communicating information over at least one of a wired or wireless network.

It is another object of the present invention to provide a system and method which remotely monitors the status and performance of a plurality of mail boxes within a service region, and which then simultaneously manages the operation and collection of mail from mail boxes based on the status and performance information.

It is another object of the present invention to provide a system and method of the aforementioned type which is interactive in nature.

These and other objects of the present invention are achieved by providing a system and method which makes pre-sort mailing services available to customers who cannot individually satisfy the requirements of a postal service for pre-sort mail. In accordance with one embodiment, the method includes two steps. In the first step, a collection of mail addressed to a same geographic area is received from each of a plurality of locations. The amount of mail collected from each location is preferably less than a minimum number required to qualify for a pre-sort rate offered by the postal service. In the second step, the collection of mail from each location is combined into a set or bundle which at least equals the minimum number required to qualify for the pre-sort rate. Each piece of mail in the set may include postage corresponding to a customer discount mailing rate, which is less than a standard mailing rate required by the postal service but greater than the pre-sort rate.

Additional steps of the method include obtaining a profit for each piece of mail in the set. The profit is computed based on a difference between the customer discount mailing rate and the pre-sort rate. The method may also include arranging to collect the mail from each location, and arranging to deliver the bundled set of mail to the postal service. The arranging steps may be performed by the same party who performs the pre-sorting steps or by a third party under contract. Also, the mail received from each location may include a mark indicating either that the mail is pre-sorted mail or the customer discount rate. The system of the present invention implements the steps of the method.

A second embodiment of the method of the present invention includes three steps. In the first step, a collection of mail addressed to a same geographic area is received from each of a plurality of customers. The amount of mail received from each customer is preferably less than a minimum number required to qualify for the pre-sort rate offered by a postal service. In the second step, the collection of mail from each customer is combined into a bundle which includes at least the minimum number needed to qualify for the pre-sort rate offered by the postal service. In the third step, a profit is computed for each piece of mail in the set. The profit is computed based on a difference between a customer discount mailing rate and a presort rate, under circumstances where the customer discount mailing rate lies between a standard mailing rate and a pre-sort rate. Additional steps of the method include providing a mail box for receiving mail from customers who may not qualify for a pre-sort rate, and arranging to collect mail from the mail box on a periodic basis.

The methods of the present invention are advantageous because all parties involved benefit. For example, the customer benefits by receiving a reduced postage rate which could not otherwise be realized from the services of conventional pre-sort houses. The postal service benefits because it receives pre-sorted mail which can be processed faster and more cost efficiently than unsorted mail. And, the party implementing the invention benefits by receiving a profit based on the difference between the customer discount mailing rate and the pre-sort rate for each piece of pre-sorted mail.

The present invention also includes multiple embodiments of a smart mail box. A first embodiment of the mail box includes a container for holding mail and a processor which performs a mail-related function. The box also includes a slot for receiving the mail and a protector which blocks access to the slot. In operation, the processor may be programmed to control the protector to allow access to the slot. The protector may take a variety of forms. According to one aspect of the invention, the protector includes a retractable door. According to another aspect of the invention, the mail box includes a lock and the processor controls the protector to allow access to the slot when an authorized key is input into the lock. According to another aspect of the invention, the mail box includes a card reader which sends a signal to the processor when the card reader reads an authorized access card. The processor then removes the protector in response to the signal, for example, by activating one or more stepper motors.

A second embodiment of the mail box includes a processor and a display. The processor may be programmed to output information relating to a status the box on the display. This information may indicate a state of fullness of the mail box, a postage rate, or a schedule of mail pick-up times to name a few. Access and advertising information may also be output on the display. In addition to these features, the box may include a protector for blocking access to the display and/or an input slot.

A third embodiment of the mail box includes a scale for weighing mail and a processor which outputs an indication of a state of fullness of the box based on a weight signal from the scale. The mail box may also include a communications unit which transmits a signal through a network indicating the state of fullness of the box.

A fourth embodiment of the mail box includes a detector which detects an amount of mail in the box. The detector operates by sensing a height of mail in an internal container. A processor then computes the amount of mail in the container based on a signal output from the detector. The detector preferably includes an optical transmitter aligned with a receiver located at a predetermined height within the container. The height may correspond to a full capacity of the box.

A fifth embodiment of the mail box has an inner volume which expands when a detector determines that the mail box is full. The expansion is made possible by a unique construction which includes: a housing disposed over a container used for collecting mail, and a motor which moves the housing relative to the container. When the detector determines that the container is full, a processor activates the motor to raise the housing, thereby increasing the mail-holding capacity of the box.

A sixth embodiment of the mail box also has an expanding inner volume. Unlike the fifth embodiment, this embodiment of the invention includes: a detector which detects an amount of mail in the box, and a motor connected to the detector. When the detector determines that the box is full, a processor activates a motor to move a position of the detector based on a signal output from the detector, thereby effectively increasing the mail-holding capacity of the box.

Any one of the embodiments of the mail box of the present invention previously described may include features of any another embodiment. These embodiments may also include a variety of other features. For example, the mail box of the present invention may include a communications unit which transmits signals from an internal processor of the box or receives signals from an external source. The signals may be transmitted over a wireless or wired link, or both, and the link may be unidirectional or bidirectional.

The mail box may also include a customer call button which, when pushed, causes a processor to establish a communications link with a remote terminal. An operator at the remote terminal may then speak to the customer using a speaker in the mail box. A security device may also be included to provide an anti-tampering function.

The present invention is also a mail processing system which includes at least one mail box including a first communications unit and a management center including a second communications unit. In operation, the first communications unit transmits status and performance information to the second communications unit, and the second communications unit transmits control information to the first communications unit. This embodiment of the present invention is advantageous because it may be used to integrate the pre-sorting method of the invention with any of the embodiments of the smart mail box of the invention.

### BRIEF DESCRIPTION OF THE DRAWINGS

FIG. 1 is a diagram showing a region of service in which the method of the present invention may be implemented for processing pre-sorted mail;

FIG. 2 is a diagram of a mail box which may be used in the region of service shown in FIG. 1;

FIG. 3 is a rate table which may be used in accordance with the method of the present invention for processing pre-sorted mail;

FIG. 4 is a flow diagram showing steps included in the method of the present invention for processing pre-sorted mail;

FIG. 5 is a diagram of postal information which may be included on a letter submitted for pre-sorting in accordance with the method of the present invention;

FIG. 6 is a diagram showing one possible route for picking up mail processed in accordance with the method of the present invention;

FIG. 7 is a diagram of one possible arrangement which may be used to sort mail in accordance with the method of the present invention;

FIG. 8 is a diagram of a money exchange which may take place in accordance with the method of the present invention for processing pre-sorted mail;

FIG. 9 is a diagram of a mail box in accordance with one embodiment of the present invention;

FIG. 10 is a diagram of a mail box in accordance with another embodiment of the present invention;

FIG. 11 is a diagram of a mail box in accordance with another embodiment of the present invention;

FIG. 12 is a diagram of a mail box in accordance with another embodiment of the present invention;

FIG. 13 is a diagram of a level sensor used in a mail box in accordance with another embodiment of the present invention;

FIG. 14 is a diagram of a mail box in accordance with another embodiment of the present invention;

FIG. 15 is a diagram of a mail box in accordance with another embodiment of the present invention;

FIGS. 16(a)-16(c) are diagrams showing a mail box in accordance with another embodiment of the present invention, and FIG. 16(d) shows an alternative configuration for this embodiment.

FIG. 17 is a diagram of a mail box in accordance with another embodiment of the present invention;

FIGS. 18(a)-18(c) are diagrams showing a mail box in accordance with another embodiment of the present invention;

FIG. 19 is a diagram of a mail box in accordance with another embodiment of the present invention;

FIG. 20 is a diagram of a mail box in accordance with another embodiment of the present invention;

FIG. 21 is a diagram of an embodiment of the system of the present invention for managing the processing of mail;

FIG. 22 is a diagram of a computer screen which may be generated at a management center included in the system shown in FIG. 18; and

FIG. 23 is a diagram showing on way in which any of the mail boxes of the present invention may be powered.

### DESCRIPTION OF THE PREFERRED EMBODIMENTS

The present invention is a method for providing a service which is not now nor has ever been offered by any public or private entity in the mailing or shipping industry. This method is based on pre-sorting letters, parcels, packages and/or other items to be mailed or shipped before these items reach the mailing or shipping carrier. The invention is unique, in at least one respect, in that while pre-sorting services have existed heretofore, none have targeted the specific market which is the focus of the present invention, nor have any of them taken the approach the invention takes in providing services in this market. The present invention therefore lays the foundation for a new and innovative business which is valuable from both a public policy standpoint and in the eyes of the private sector.

The present invention is also a mail box which contains a processor for performing a variety of mail management functions. The mail box is ideally suited for use with the pre-sorting method of the invention, however the mail box may also be used to perform other applications.

The present invention is also system and method for managing the processing of mail, from the point of collection to the point of submission to a carrier. This system and method is ideally suited for integrating the pre-sorting method and mail box embodiments of the invention, although other uses are contemplated. A detailed description of the embodiments of the invention will now be provided.

The Pre-Sorting Method

The method for processing pre-sorted mail in accordance with a first embodiment of the present invention is based on the creation of an intermediary between a mailing or shipping carrier and customers who desire to use the services of the mailing or shipping carrier to send letters, parcels, packages, periodicals, or other items. The mailing or shipping carrier may be the United States Postal Service, a postal service of a foreign country, or even a private carrier such as Federal Express or the United Parcel Service. The method is particularly well suited for pre-sorting items of mail to be sent through the U.S. Postal Service, and therefore for illustrative purposes only the balance of this discussion focuses on this particular application. Those skilled in the art can appreciate, however, that the invention is not intended to be limited to this application.

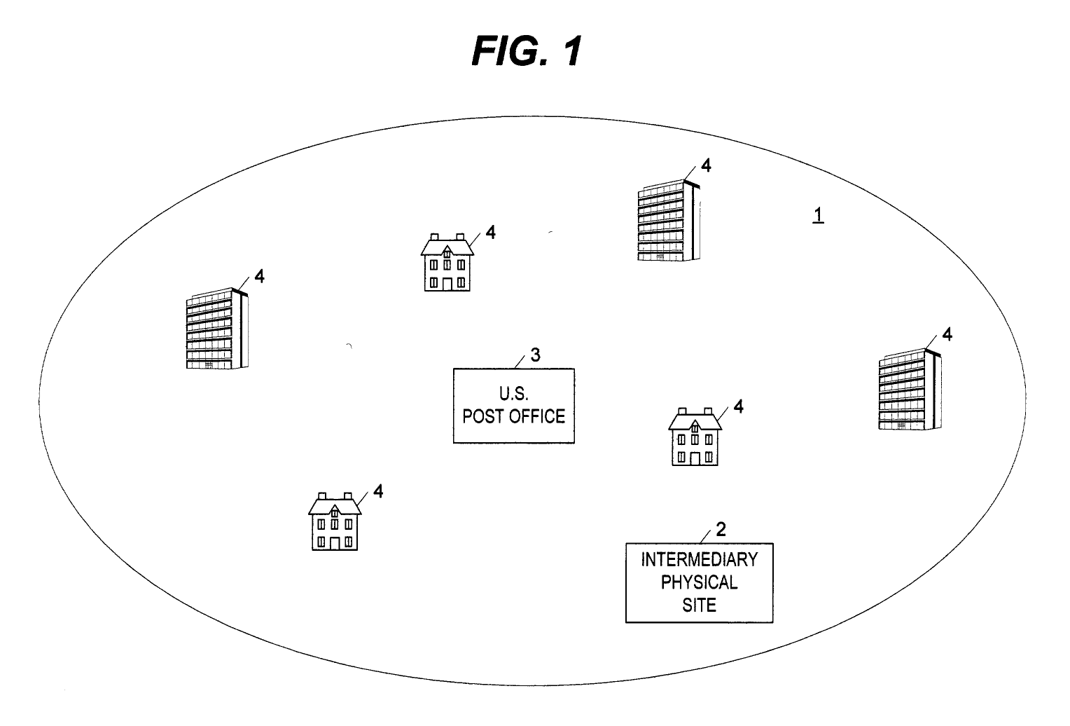

Referring to FIG. 1, the method of the present invention may be implemented within a region of service 1 which includes at least one physical site 2 of the intermediary, at least one post office site 3, and a plurality of customer sites 4. The region of service may be a large metropolitan area such as the District of Columbia and its surrounding suburbs. Alternatively, the region may include more modestly populated or even rural areas. The size of the service region is not to be restricted by the foregoing examples. Rather, this region may be limited only by the resources of the intermediary in terms of its ability to serve customers in any given area. If significant enough, these resources may therefore allow the intermediary to service a plurality of metropolitan areas.

The physical site of the intermediary is preferably located inside of the region of service, however this is not a necessity. For reasons that will become apparent below, the physical site may include equipment for sorting letters, packages, parcels, and/or other items which the customers desire to mail. The physical site also includes an office with personnel for managing receipt of the mail and for then distributing the mail in pre-sorted form to the post office. A computer system may also be included for assisting management personnel in performing these duties.

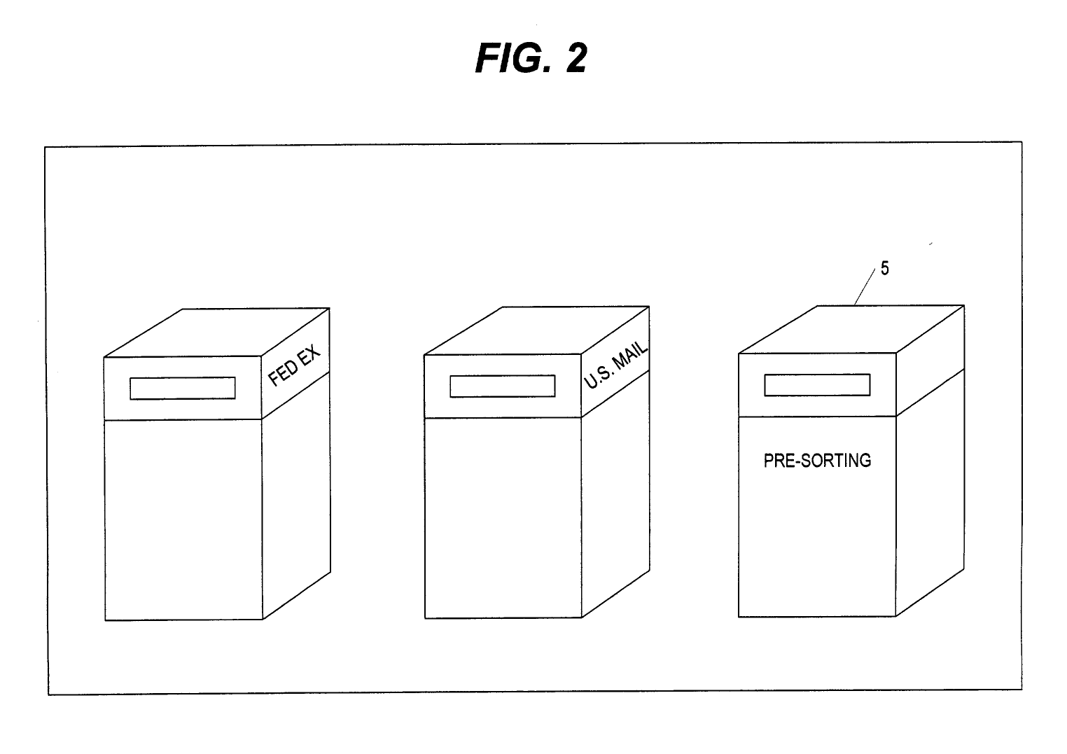

The customer sites may include business offices, private residences, or a combination thereof. The invention is particularly well suited to serving customers in office buildings. Many buildings of this type have mail rooms which businesses use to access the mail and/or one or more private carrier services. As shown in FIG. 2, these mailing rooms may be equipped with a mail box 5 provided by the intermediary for allowing businesses in the building to use the service furnished by the method of the present invention. The mail box may include printed information for guiding a customer in using the box. This information may indicate, for example, eligibility requirements for accessing the service and the types of mail which can be accepted, as well as other information. A more detailed description of this mail box is provided in subsequent portions of this discussion.

The method of the present invention provides a pre-sorting service which operates within the guidelines of the U.S. Postal Service, while simultaneously recognizing and supplying the needs of a market which has not now nor ever before been recognized by conventional methods. Implementation of the invention is made possible by a change in policy effected by the U.S. Postal Service. Under this policy, in order improve efficiency, costs, and the speed of delivery of the mail, the U.S. Postal Service began offering discounted postal rates for pre-sorted mail. These discounted rates can only be realized provided mail is (1) sorted in groups addressed to a same geographical area and (2) those groups include a minimum of 500 pieces of mail. In other words, the discounted pre-sort rates offered by the postal service are unavailable for small lots of mail, even if those lots are addressed to a same geographical area.

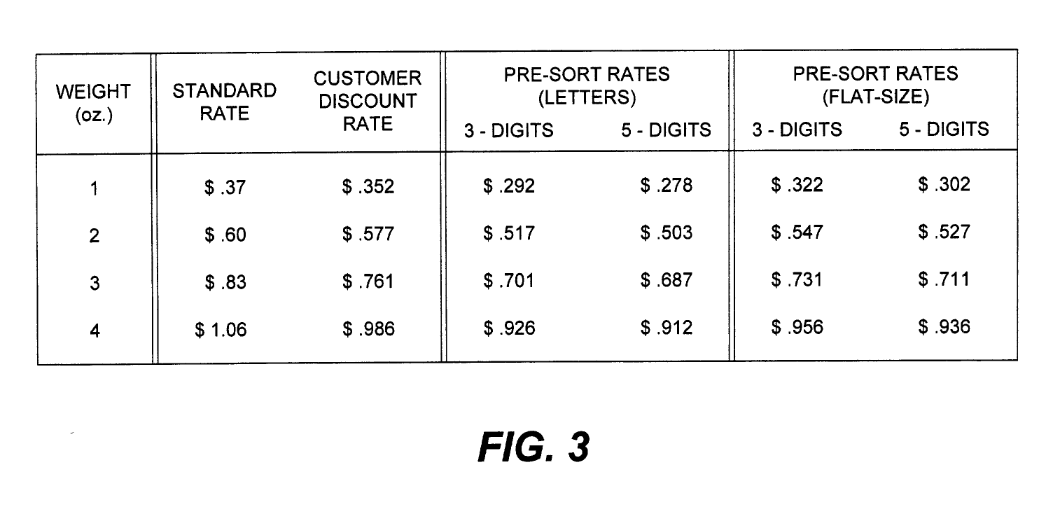

FIG. 3 is a reproduction of a recent table published by the U.S. Postal Service. (Notice 123, RATEFOLD, Effective Jun. 30, 2002, posted Apr. 20, 2002). This table shows graduated standard rates and customer discount mailing rates for letters that weigh between 1 to 4 ounces. The first row of this table shows, for example, that the standard postage for mailing a letter weighing one ounce is 37 cents. If this letter is included in a bundle which meet the 500-letter minimum requirement, customers are permitted to pay a discount rate of $0.352 cents for mailing that letter.

To provide the public with an incentive to use this pre-sorting service, the U.S. Postal Service has provided a second discount rate, which hereinafter will be referred to as a pre-sort rate. The pre-sort rate is the postage at which the U.S. Postal Service will allow private, so-called “pre-sort” houses to submit conforming bundles of pre-sorted mail. These pre-sort houses collect mail from customers, each of whom mail 500 letters or more usually on a daily basis to addresses which lie within a common geographical area. The function of these pre-sort houses is to sort the letters and submit them to the post office in sorted bundles of 500 letters or more. The post office, in return, then issues a check to the pre-sort house for the difference between the customer discount mailing rate and the pre-sort rate.

The pre-sort rate is set by the post office depending upon how close the letters in each bundle are geographically related. This relatedness is determined based on how many zip-code digits addressee information on the letters have in common. For example, as shown in the table of FIG. 3, if a one-ounce letter in a conforming bundle has three digits of a same zip code in common with the other letters in the bundle, the pre-sort rate is set at $0.292. If five zip-code digits are in common, the pre-sort rate is set at $0.278. According to this conventional method, the pre-sort houses receive a check from the post office equal to the difference between the customer discount mailing rate and the pre-sort rate for each letter in the conforming bundle.

The table in FIG. 3 also shows that a separate set of rates is provided for flat-size envelopes, which include, for example, envelopes larger than a standard-size business envelope. While no pre-sort rate is given for letters weighing over four ounces, pre-sort rates are given for flat-size envelopes greater than this weight.

For economic reasons, conventional pre-sort houses have only targeted the market defined by the literal guidelines of the U.S. Postal Service. That is, in order to make a profit, conventional pre-sort houses only collect mail from companies that can either meet or exceed the 500-letter minimum requirement for receiving a presort discount from the Postal Service. Consequently, companies who desire to mail less than the minimum number of letters to qualify for the customer discount mailing rates offered by the Postal Service must either mail those letters at the standard rate, or hold off mailing the letters until they have enough to meet the minimum number required for the discount. For many businesses, this is not a reasonable option because their mail is either time sensitive or in such small quantities that the 500-letters requirement cannot be met.

The Inventor of the present invention provides service to a market which has not been recognized by conventional pre-sort houses, the U.S. Postal Service, or any other public or private entity. This market includes individuals and/or businesses (e.g., small businesses) which cannot meet with any expectation of consistency the requirements to qualify for the pre-sort discounts provided by the Postal Service. As previously discussed, conventional pre-sort houses do not engage in business practices which allow individuals or small businesses to benefit from these services. The present invention, however, provides a method which allows these entities to receive pre-sort discounts, even though they cannot meet the minimum letter requirement. All parties involved therefore benefit. Specifically, individuals and small businesses benefit by receiving a reduced postal rate for their mail. The Postal Service benefits because it will receive a greater amount of pre-sorted mail, which in turn will lower costs and improve efficiency. And, an intermediary practicing the method of the present invention will benefit by receiving a substantial profit. The details of the method of the present invention will now be discussed.

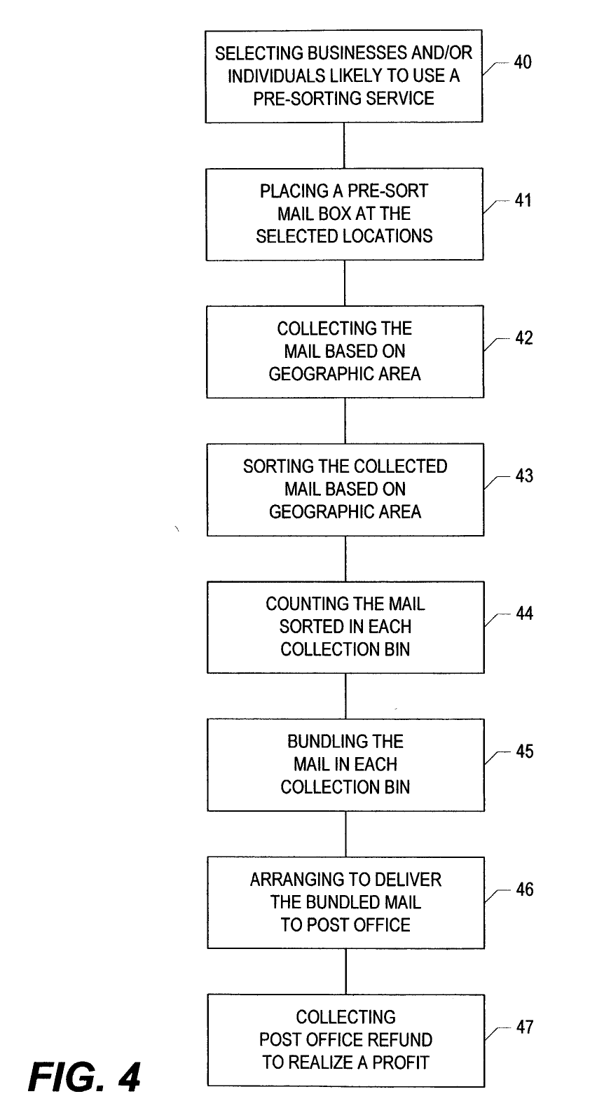

Referring to FIG. 4, the method of the present invention includes as an initial step selecting locations of businesses and/or individuals who may be interested in benefitting from the pre-sorting service offered by the U.S. Postal Service. (Block 40). This may be performed by targeting specific small businesses or locating highly populated areas within a given region of interest. Highly populated areas may include office buildings, malls, business courtyards, hotels, hospitals, common areas in a community, grocery stores to name a few. Preferably, the selected locations are ones which have a high probability of receiving mail addressed to the same geographic locations. This is especially likely to occur in metropolitan areas and its surrounding suburbs. It is probable, for example, that many businesses in the suburbs of a city will send mail to locations within the city.

A second step of the method includes placing a mail box at each of the selected locations. (Block 41). The mail box preferably includes information which identifies it in a conspicuous manner as being one for only receiving pre-sort mail. This may be accomplished by including a step-by-step guide instructing customers as to the purpose of the box and how mail may be sent using box. In accordance with one aspect of the invention, the mail box may be a type restricted to receiving only certain sizes of mail. To aid customers, an outline of the permissible sizes of mail may be printed on the box. Other information may also be included such as pick-up times and customer discount rates for the pre-sorted mail. Customers may be notified of the discount rates in other ways, such as on the website of the intermediary or the Postal Service, through mailing literature, or by other forms of notice.

The mail boxes of the invention may also be in the form of mail chutes such as those found on the floors of an office building. A collection bin placed in the basement of the building may then be provided to collect the mail inserted into the chutes. The mail box may also be of a type formed into the wall without a chute.

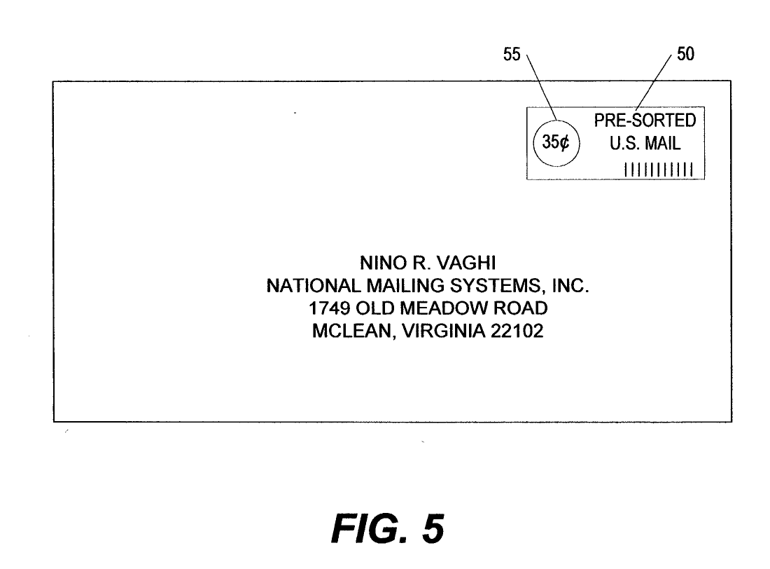

In order to use the mail boxes of the present invention, it is preferable for customers to have advanced knowledge of the customer discount rate. This knowledge will allow customers to set the postage-computing machines in their offices to print a postal mark indicating that the mail is pre-sort mail, the customer discount mailing rate, or both. FIG. 5 shows an example of such a mark placed on an envelope, where area 50 corresponds to a “pre-sorted” identifier and area 55 corresponds to customer discount rate of “35 ¢.” Those skilled in the art can appreciate that many types of conventional postage-computing machines can be set to provide identifiers of this type, either directly imprinted on an envelope or on a label to be attached to an envelope. By setting postage to 35 cents, customers who are not eligible to receive pre-sorting services from conventional pre-sort houses can immediately realize cost savings using the method of the present invention.

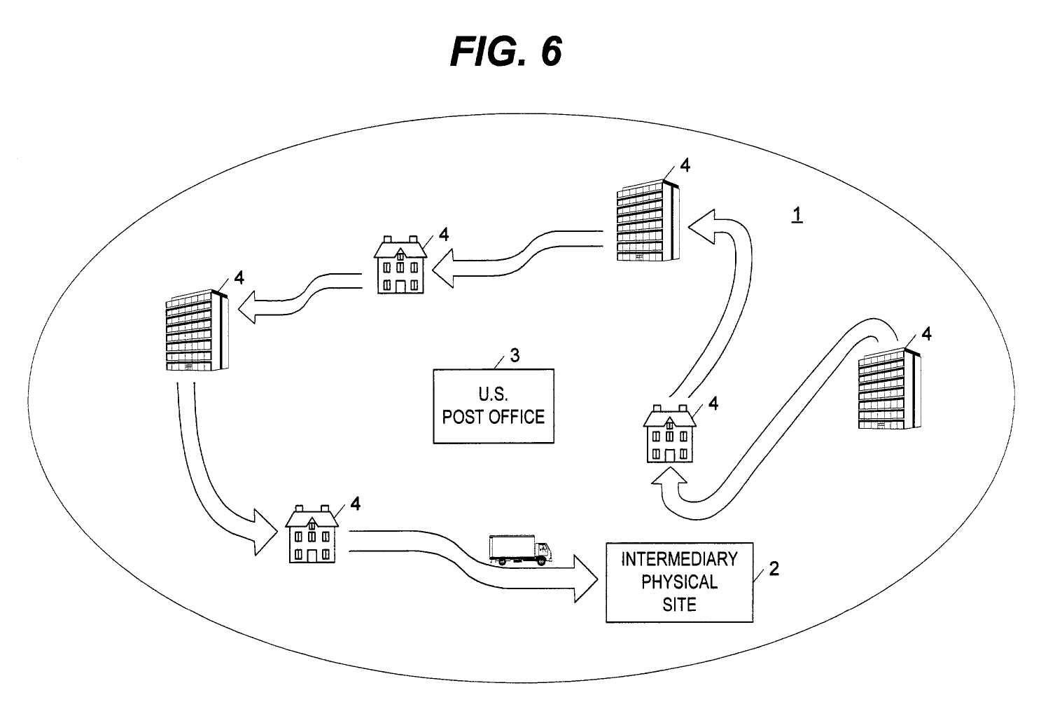

A third step of the method includes collecting the mail in each of the mail boxes on a periodic basis. (Block 42). The mail may be collected every day or every predetermined number of days. Further, an intermediary implementing the method of the present invention may employ a team of couriers to pick up the mail, or alternatively mail pick-up may be contracted out to a third party. Also, if desired, mail may be hand-collected directly from selected individuals or businesses, thereby bypassing the need to collect mail from the mail boxes for at least these customers. Once the mail is collected, it is delivered to a physical site of the business entity practicing the method. The collection step of the method may be exemplified by route 60 shown in FIG. 6.

A fourth step of the method includes sorting the collected mail based on geographical area. (Block 43). This may be performed using conventional mail-sorting machines which read address information on each item of mail and then direct the mail to appropriate sorting bins. The geographical areas are preferably designated by zip-code information on the mail. To be consistent with existing U.S. Postal Service policy, the mail in each bin may related by at least three zip-code digits. A first sorting bin may therefore collect mail for a geographical area corresponding to the zip-code area 221XX, a second sorting bin may collect mail for a geographical area corresponding to the zip-code area 201XX, and so on. The mail may further be sorted by type of mail (e.g., letters, flat-size mail, packages, parcels, etc.) and weight of mail (e.g., 1 oz., 2 oz, etc.).

To increase profit, an intermediary implementing the invention may set the sorting machines to sort mail in groups which have 4 or even 5 zip-code digits in common. As shown by the Table in FIG. 3, the U.S. Postal Service offers a lower pre-sort rate when bundles of mail are submitted with 4 and 5 common zip-code digits. This translates into increased profits because the intermediary receives a check from the Postal Service equal to the difference between the customer discount mailing rate and the pre-sort rate.

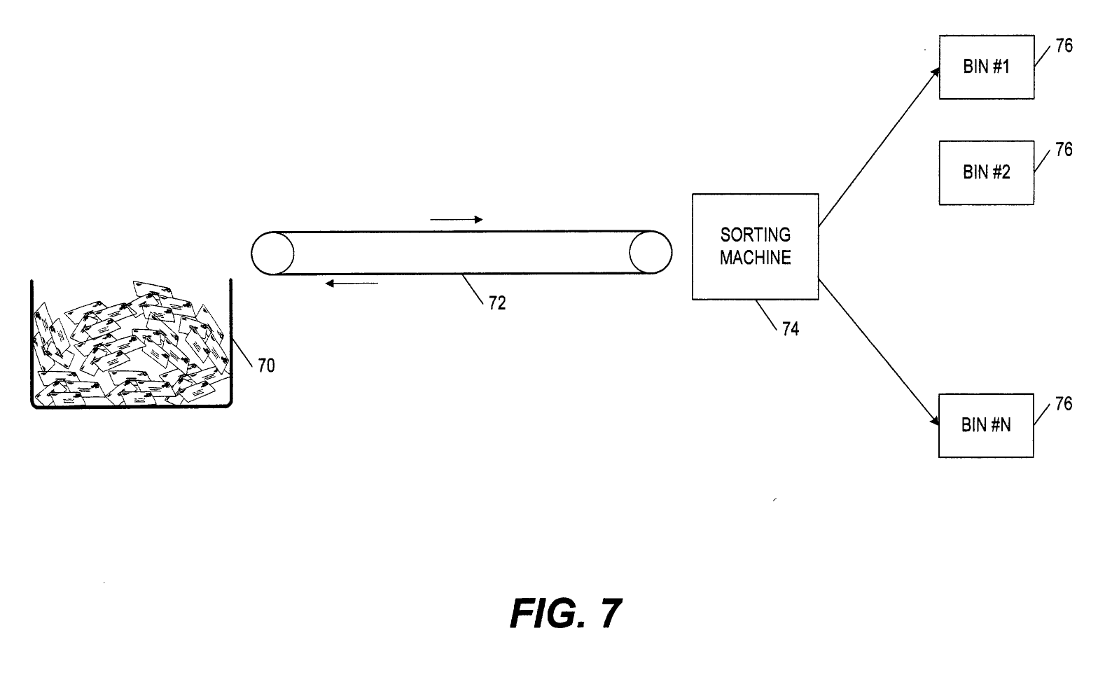

FIG. 7 provides as an example of how the sorting step of the present invention may be performed. In this figure, letters collected from customers or customer mail boxes are dumped into a hopper 70. The letters are then sequentially transported along a conveyer 72 to a sorting machine 74. The sorting machine reads the address on each letter, weighs the letter, and then routes the letter to one of a plurality of bins 76. Bin #1 collects one-ounce letters having three zip-code digits in common, Bin #2 collects two-ounce letters having 5 zip-code digits in common, and Bin #N collects four-ounce letters having 4 zip-code digits in common. If desired, the sorting step of the invention may be performed by hand.

A fifth step includes counting the pieces of mail in each sorting bin. (Block 44). This step may be performed by hand or machine. The mail in each bin must total at least the minimum number required under existing Postal Service policy to qualify for the pre-sorting discount. Presently, this minimum number is 500. If Postal Service requirements, those skilled in the art can appreciate that the present invention may be changed to meet the new requirements.

A sixth step includes bundling the piece of mail in each bin. (Block 45). Once the minimum number requirement has been determined to be satisfied, the mail is preferably bundled based on type of mail. For example, one bundle may include 500 or more one-ounce letters, and another bundle may include 500 or more 5-ounce flat-size pieces of mail. Bundling is performed in accordance with existing U.S. Postal Service requirements for receiving pre-sorted mail. This information is set forth, for example, in the publication “Quick Service Guide,” January 2001, published by the U.S. Postal Service.

A seventh step includes arranging to deliver the pre-sorted and bundled mail to a post office designated for receiving mail of this type. (Block 46). Delivery of the bundles may be performed by the intermediary or by a contract partner of the intermediary.

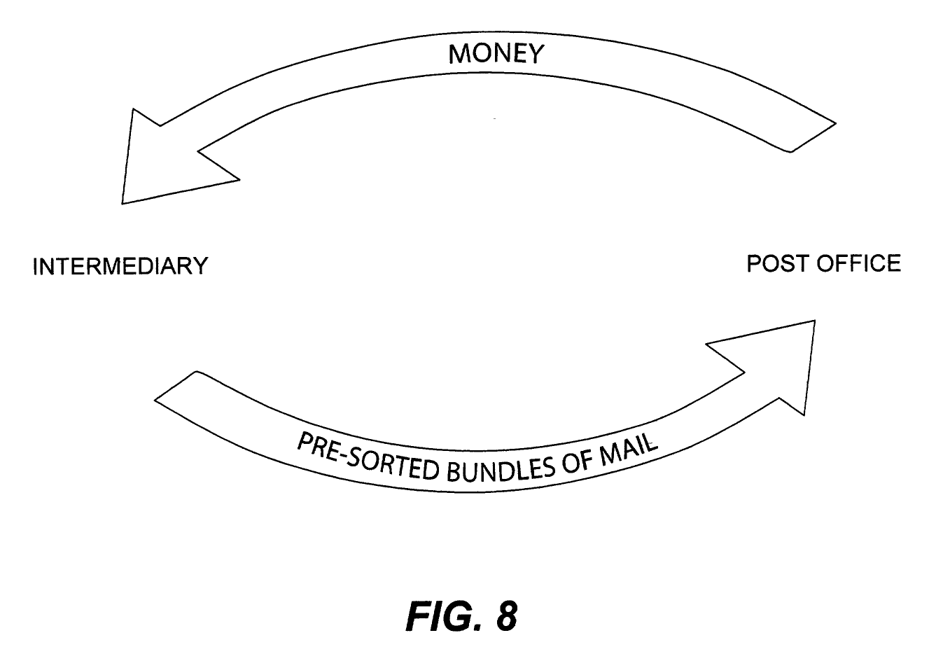

An eighth step includes collecting funds from the post office to thereby allow the intermediary to realize a profit based on the pre-sort rate. (Block 47). For example, for a bundle of one-ounce letters, the difference between the customer discount mailing rate and the pre-sort rate is collected for each letter in the bundle. Thus, based on the table in FIG. 3, the intermediary would collect $30 for a bundle of 500 1-ounce letters having 3 zip-code digits in common. This is computed by subtracting the pre-sort discount mailing rate ($0.292) from the customer discount rate ($0.352), and then multiplying the difference ($0.06) by 500. Upon verification, the post office may issue a check to the intermediary at the time of submission of the bundle, or alternatively the post-office may credit an account of the intermediary. Those skilled in the art will appreciate that other payment methods are also possible. FIG. 8 illustrates an exchange that may take place in accordance with the eighth step of the present invention.

By processing large numbers of bundles, it becomes clear that an intermediary practicing the method of the present invention can realize substantial profits, while simultaneously providing a new service to an entire segment of the market unrecognized by conventional pre-sort houses. To improve or enhance these advantages, the method of the present invention may include a number of optional steps.

One optional step includes having each of the customers sign a licensing agreement with the intermediary. This agreement would set forth the conditions under which pre-sorting services would be provided. In return for the opportunity to partake of these services, the agreement may require the customers to pay an initiation fee, an annual fee, or any number of other fees. The money generated from this income may then be used for capital equipment improvement, cover administrative costs, and/or may be collected as profit.

In order to implement the pre-sorting method of the present invention, it is understood that the intermediary and/or the customers of the intermediary may be required to be certified/registered by the post office. This may be accomplished, for example, by filing out Postal Service Form 8096, entitled Request to Pay Postage Refunds to Presenter of Mail, or some equivalent thereof. It is also understood that the intermediary may require customers to execute a license and pay a fee in order to benefit from the intermediary's services. This license may, for example, require an up-front payment coupled with periodic (e.g., annual) payments or a lump-sum payment. The licensing fees may allow the intermediary to cover adminstrative costs and expenses associated with a practical implementation of the method.

### Mail Box

The present invention is also includes multiple embodiments of a mail box.

A first embodiment of the mail box may be used for collecting pre-sort mail in accordance with the method of the present invention. This mail box may be configured so that access is gained only with an authorized key. This may be accomplished in a variety of ways. For example, a door equipped with a locking mechanism may be provided over an input slot of the box. Only those customers who have been given a key, for example, by the intermediary, may open the door to drop pre-sort mail in the box. The key may be a mechanical key or an access card storing authorization information in electronic, magnetic, or optical form. A reader integrated into the mail box may be adapted to read the authorization information from the card, and when a match occurs with information stored in a memory, access is given to the input slot of the box. The locking mechanism protecting the input slot may also be in the form of a combination lock or one based on biometrics. While the mail box of the present invention is ideally suited to receiving pre-sort mail, the invention is not intended to be limited in this manner. Those skilled in the art can appreciate that the mail box of the present invention may be used to receive any type of mail.

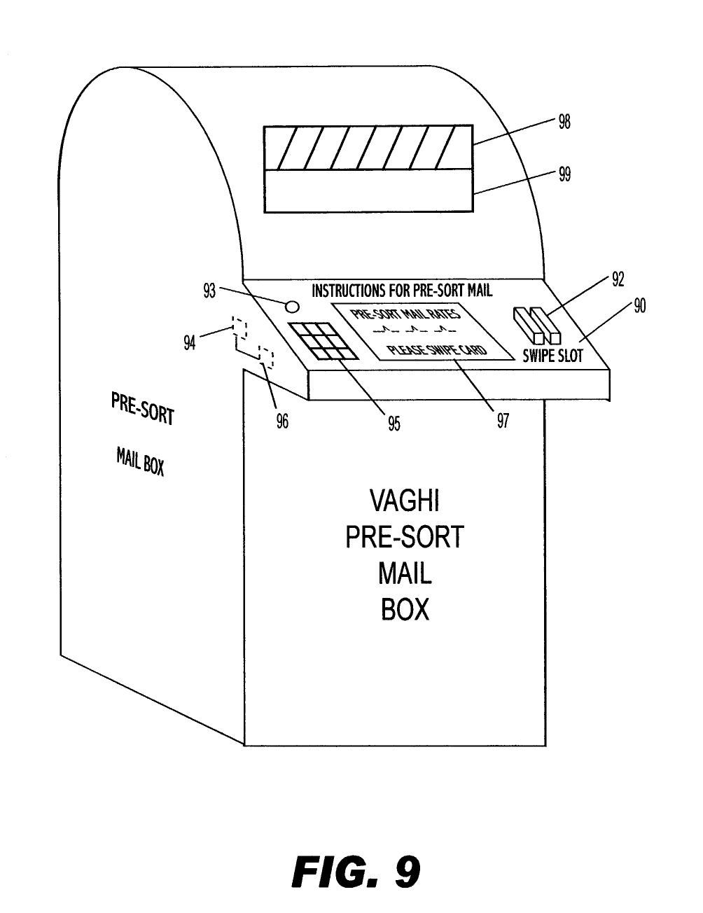

FIG. 9 shows an example of the first embodiment of the mail box of the present invention. This box includes a control panel 90 having a card reader 92, a processor 94, a memory 96, and a display 97. In operation, a customer swipes his or her access card through the card reader. If information encoded on the card matches an authorization information stored in the memory of the control panel, servo motors (not shown) engage to open a retractable door 98 covering an input slot 99 of the box.

The control panel display may be used to notify a customer of various types of information. For example, the display may provide an indication of whether a match occurred between the information read from the access card and the authorization information stored in memory. The display may also provide an indication that the box is full of mail or that service is required on the electrical components of the box. The display may also display the latest customer discount mailing rates offered by the Postal Service, as well as other information. In addition to these features, the display, or optionally the control panel, may include a customer call button 93, a keypad 95 of numbers and/or letters for entering information, for example, in connection with the management system and method of the present invention described in greater detail below.

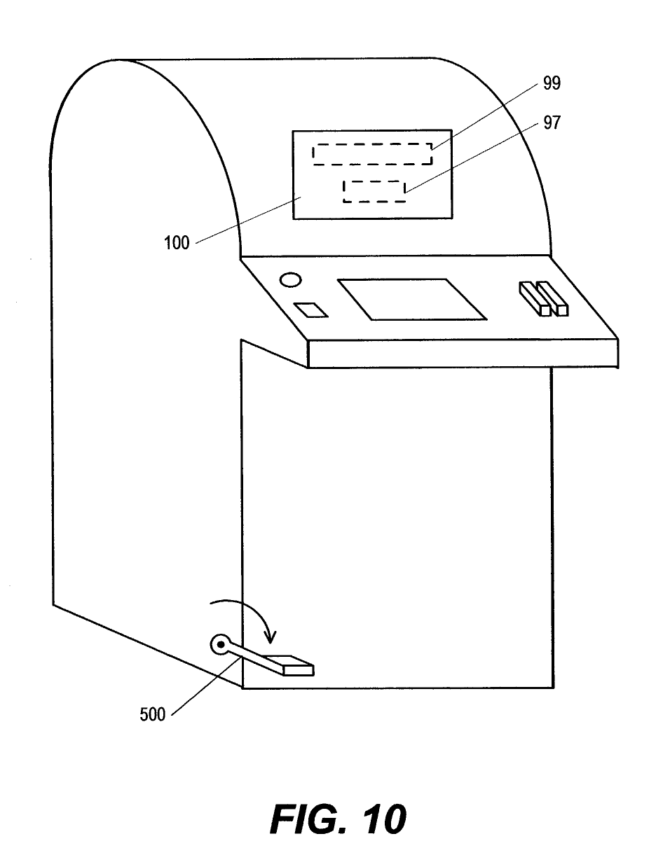

A number of other optional or alternative features may also be included on the mail box of the present invention. In accordance with another embodiment of the invention, access to the control panel may be made contingent on swiping an authorized access card through the card reader. FIG. 10 shows one way in which this may be accomplished. In this embodiment, the display 97 and input slot 99 are protected behind retractable door 100, but the card reader 92 is left exposed. When an authorized access card is swiped through the reader, an internal processor in the box engages servo motors (not shown) to open the door, thereby revealing the control panel and slot for use by a customer.

In accordance with another embodiment of the invention, the display is omitted from the mail box altogether. In this embodiment, when an access card is swiped through the reader, the retractable door protecting the input slot and/or display will automatically open. This action alone will service to inform the customer that access has been given.

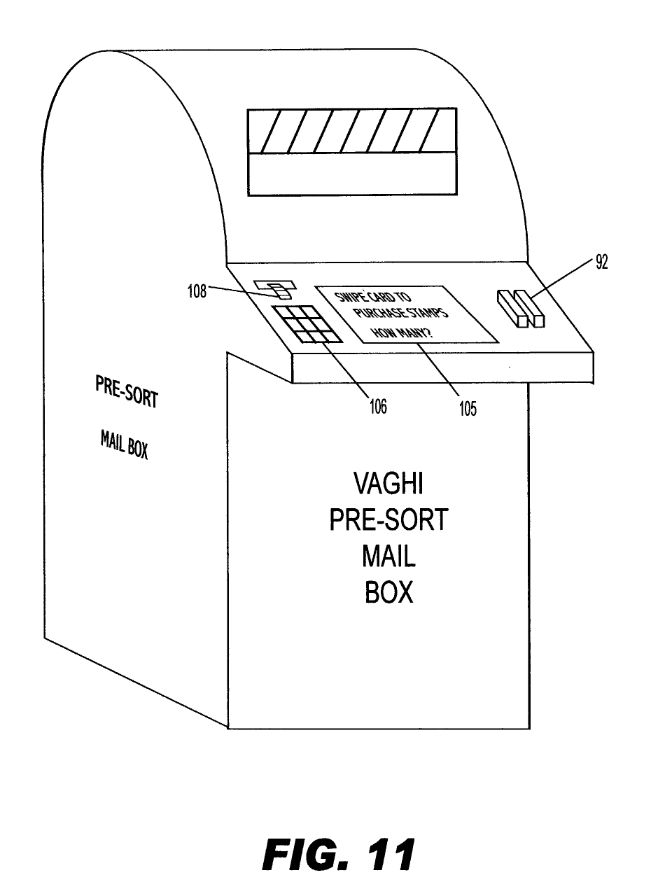

In accordance with another embodiment of the invention, the mail box processor maybe adapted to provide a mail-related service to customers. This service may include allowing customers to purchase stamps at the mail box. As shown in FIG. 11, in order to implement this embodiment the mail box may provide a menu option for purchasing stamps which may be selected on a display 105. When this option is selected, the processor may query the customer as to how many stamps he or she would like to purchase. The customer may then respond using the keyboard 106. The processor may then request the customer to swipe a smart card, debit card, credit card, or other information-bearing card through the card reader 92. If identification information read from the card is found to be authentic, the processor dispenses the requested number of stamps 108 through a port in the mail box control panel. Information for deducting the purchase price of the stamps may then be stored in memory for later transfer to the customer's account, or this information may be directly transmitted to a financial institution managing the customer's account through a communications link, or the purchase price may be deducted directly from an amount previous stored on the card.

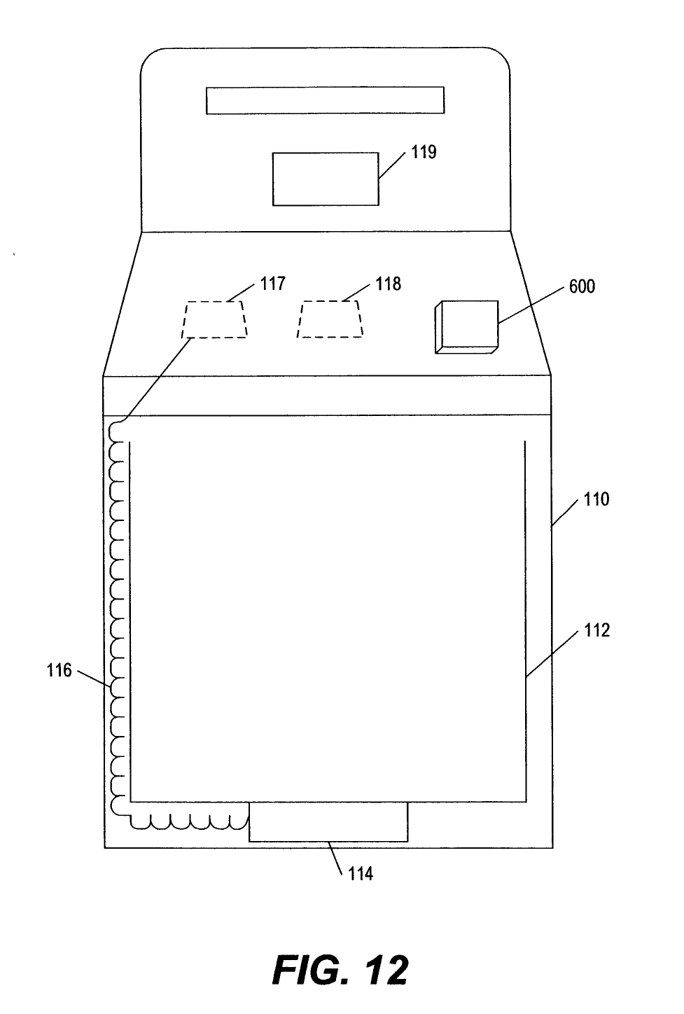

In accordance with another embodiment of the invention, a scale is included within the mail box. FIG. 12 is a front view of a mail box according to this embodiment of the present invention. In this embodiment, the box includes an outer housing 110, an internal container 112 for holding pieces of mail, a scale unit 114 having a load cell for weighing the contents of the box, and a signal line 116 which conveys a weight signal from the scale to a processor 117 in the control panel of the box. The scale is calibrated to take the weight of the internal container into consideration in giving an accurate measurement of the weight of mail inside the container. In order for an accurate measurement to be taken, the internal container may be “floating” with respect to the outer housing of the box. Springs, guides, and/or other stabilizing members (not shown) may be used to achieve this floating state.

FIG. 12 also shows that a scale 600 maybe supported on a surface of the mail box. The scale may be mechanical or electrical and may be allowed to loosely rest on the surface or, for stability, may be removably or permanently mounted to the surface using any conventional means of attachment. For illustrative purposes, the scale is shown mounted to a surface of the control panel. Scale 600 is desirable because it will allow customers to weigh items of mail before placing them into the mail box. Other uses of the scale are also possible.

In operation, the processor uses the weight signal from the scale unit to determine the remaining capacity in the box. For example, if the mail in the container reaches a certain weight pre-stored into a memory 118 of the control panel, the processor may conclude that the box is full. A warning message may then be provided on the display 119 of the box informing customers of this condition. Another message may then be displayed to notify the customer of the location(s) of other mail boxes, preferably nearby, which the customer may use. Although the scale is shown as being inside the box, the scale may be located outside of the box if desired. Further, the scale may be powered using the same source which powers the control panel.

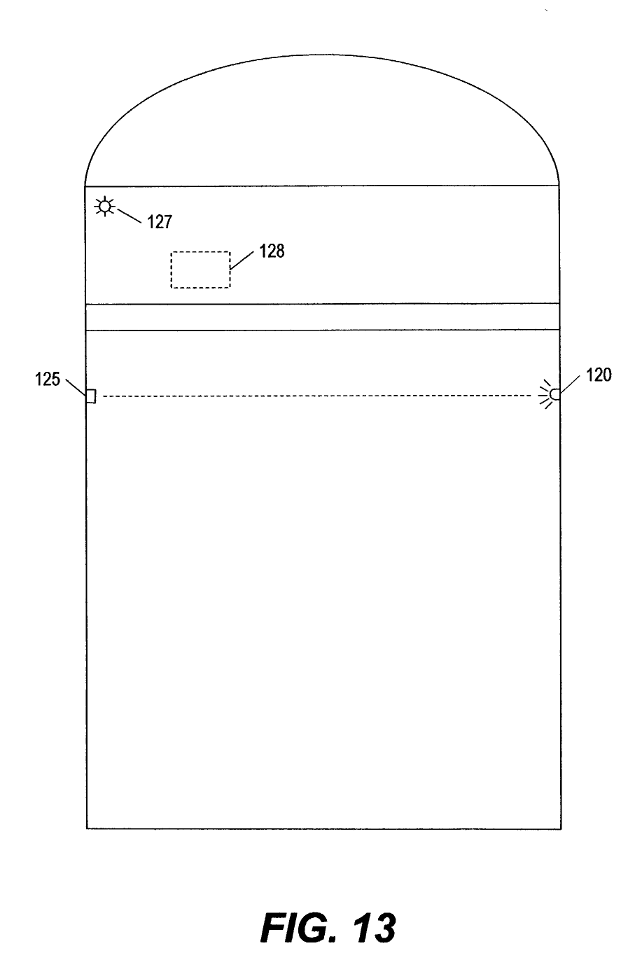

In accordance with another embodiment of the invention, in addition to or in lieu of the scale unit, the mail box may be equipped with a level sensor which is triggered when the mail in the container reaches a certain height. As shown in FIG. 13, the level sensor may include an optical transmitter 120 which projects a beam to a detector 125 at a desired height relative to a bottom of the mail box. When mail in the box reaches a height which breaks the beam, an indicator light 127 may be activated on the box. In addition, or alternatively, a processor 128 of the mail box may connected to the level sensor to detect this condition and either activate the indicator light, notify a remote operator, or both. The processor may also use the signals from the scale unit or the level sensor to notify a remotely located courier of how much mail is in the box. These aspects of the invention will be discussed in greater detail below.

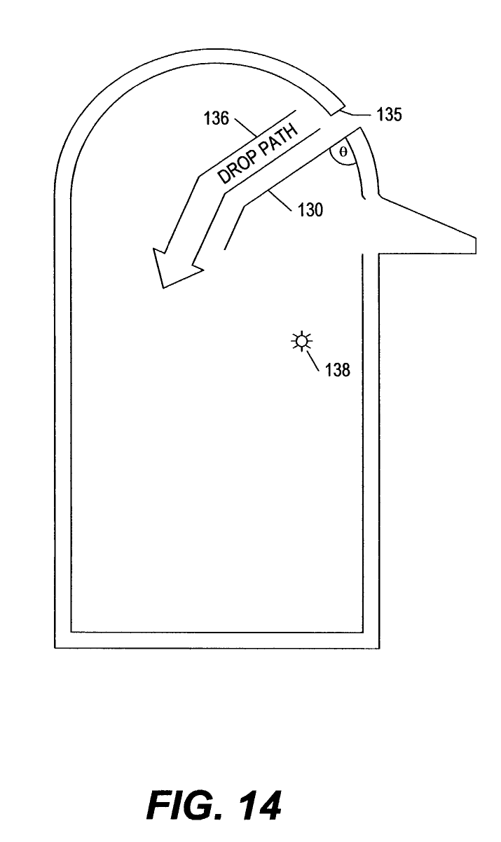

To prevent the beam from being broken when mail is deposited into the box, the beam is preferably situated at a location inside the box which does not interfere with a drop path of the mail. FIG. 14 shows, in cross-section, how this may be accomplished. In this figure, the mail box of the present invention is shown as including a chute 130 attached to the input slot 135 of the box. The chute is preferably angled in order to divert the drop path 136 of the mail away from the beam 138.

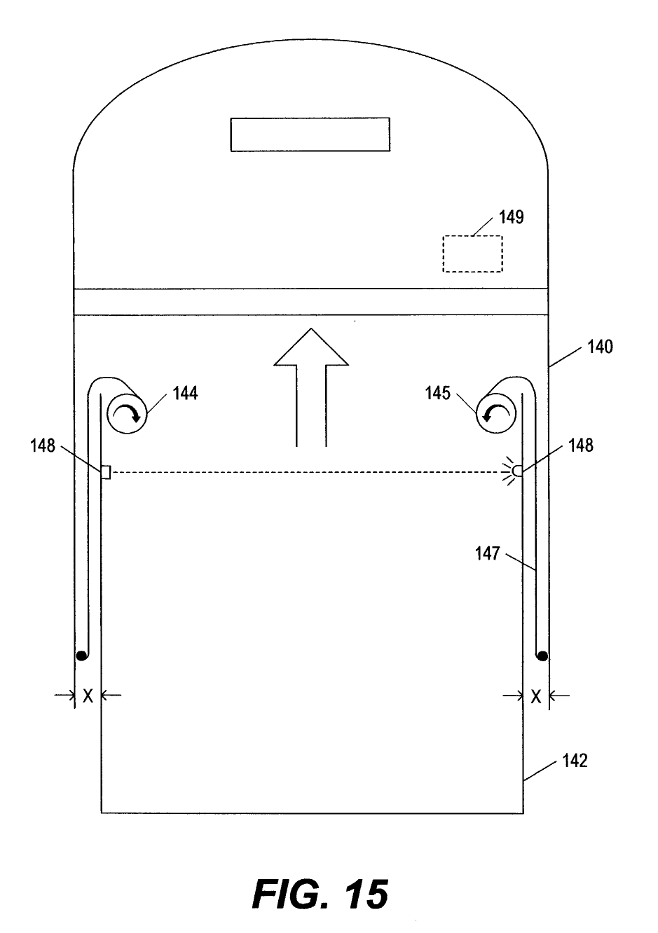

In accordance with another embodiment of the invention, the mail box may be designed to expand. This expansion may take place, for example, when the level sensor detects that the inner volume of the box is filled to capacity, or to another predetermined height. To expand the inner volume, FIG. 15 shows that the box may be constructed to include an upper housing portion 140 which fits over a lower housing portion 142. The dimensions of the housing portions are selected so that a predetermined clearance spacing “X” exists between the walls of the housing portions.

The box may also include two motors 144 and 145 which control the respective lengths of cables 146 and 147. The motors are preferably mounted to inner surfaces of the lower housing portion, and the ends of the cables are connected to inner surfaces of the upper housing portion. When the level sensor 148 detects that the inner volume of the box is filled to capacity or to another predetermined height, a processor 148 in the box controls the motors to rotate a predetermined number of times. This causes the upper housing portion to be raised (see arrow) relative to the lower housing portion by a desired amount, thereby increasing the capacity of the mail box. Guides and other stabilizing members (not shown) may be included as necessary in order to ensure that the upper housing portion slides smoothly relative to the lower housing portion and that the cables slide in a frictionless manner relative to the edges of the lower housing portion. Also, a single motor may be used to control the lengths of both cables if desired.

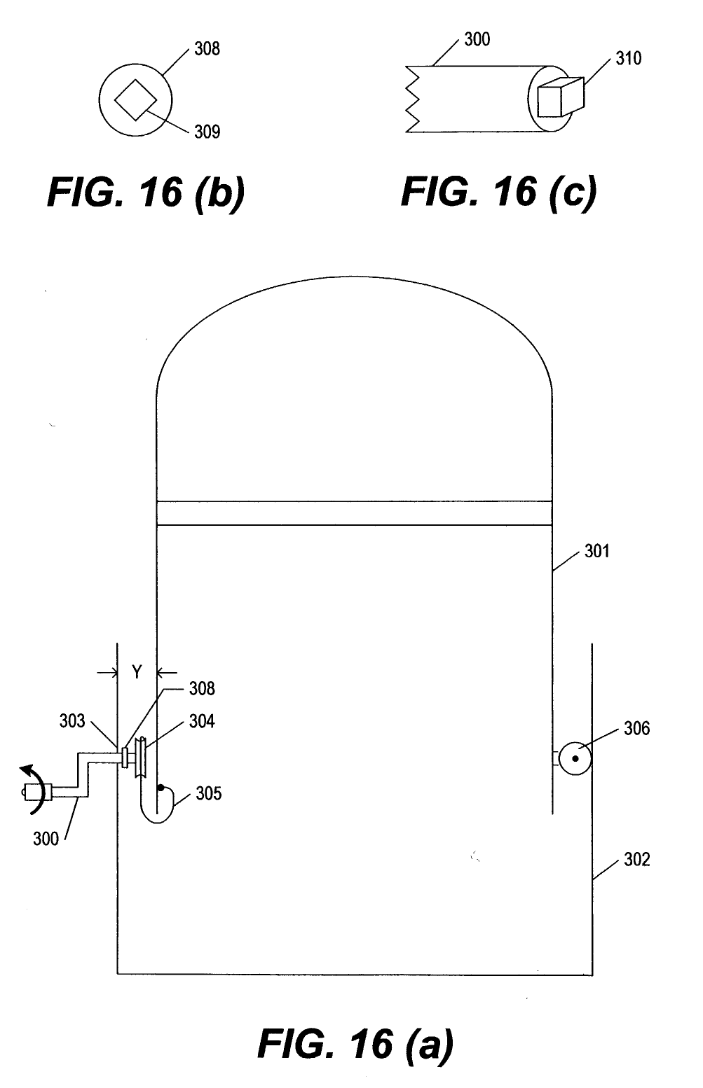

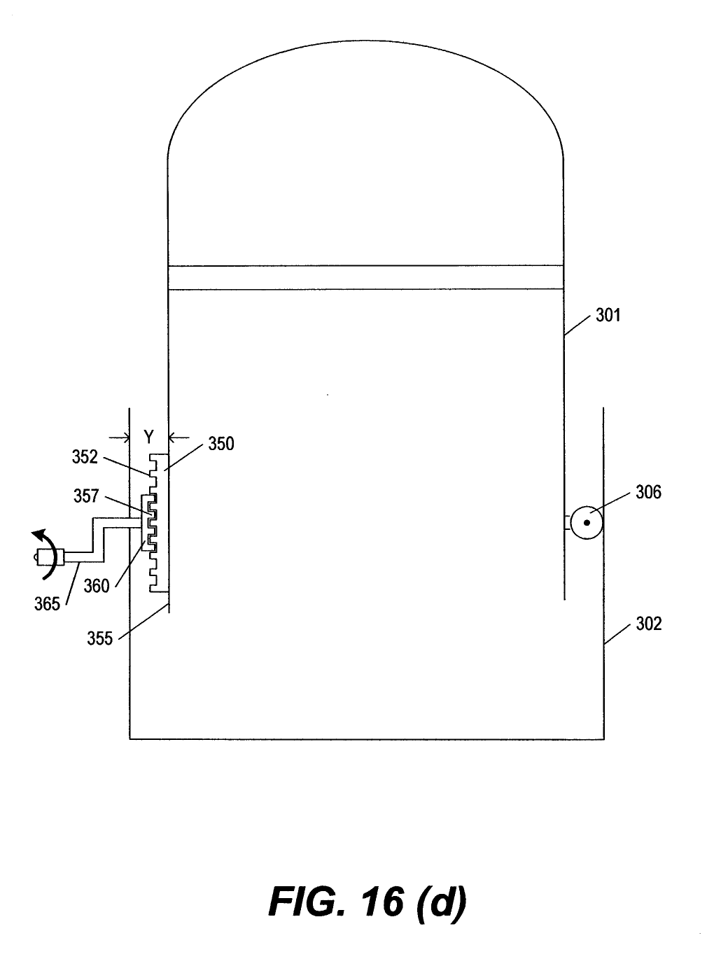

FIGS. 16(a)-16(c) show another embodiment of the mail box of the present invention. In this embodiment, a user can apply manual forces to change the mail-holding capacity of the box, for example, by using a removable crank handle 300. As shown in FIG. 16(a), the box includes an upper housing portion 301 adapted to fit within a lower housing portion 302, and the sides of the upper housing portion are spaced from the lower housing portion by a predetermined clearance “Y.” The lower housing portion includes a receiving slot 303 and a wheel 304 mounted to an inside surface of the lower housing portion adjacent the slot. The wheel holds a length of cable 305, and end of which is attached to the upper housing portion. To provide stability, a roller 306 is attached to a side of the upper housing portion opposite the side on which the wheel is located. The roller operates to reduce friction and provide a counterbalancing force as the upper housing portion moves relative to the lower housing.

As shown in FIGS. 16(b) and 16(c), the wheel includes a flange portion 308 having a connection feature 309 adapted to mate with an end 310 of the crank handle. In this illustrative embodiment, the connection feature is a square indentation and the handle end includes a complementary bolt. Those skilled in the art can appreciate, however, that the invention may use any type of conventional structure to allow the crank handle to connected to the flange of the wheel.

In operation, a user inserts the end of the handle into the receiving slot and then turns the handle. Turning the handle in one direction causes the wheel to wind the cable, thereby lifting the upper housing portion relative to the lower housing portion and thus increasing the holding capacity of the mail box. Turning the handle in the opposite direction causes the wheel to release cable, thereby lowering the upper housing portion relative to the lower housing portion and thus decreasing the holding capacity of the mail box. Guides and other stabilizing members (not shown) may be included as necessary in order to ensure that the upper housing portion slides smoothly relative to the lower housing portion and that the cables slide in a frictionless manner relative to the edges of the lower housing portion.

FIG. 16(d) shows an alternative way of implementing the crank-handle embodiment of the invention. In this embodiment, a gear track 350 is mouted on a surface 355 of the upper housing portion and a gearwheel 360 is mounted on the end of a crank handle 365. The gear track has teeth 352 which engage teeth 257 on the gear wheel, such that when the wheel is turned by the handle the upper housing is raised or lowered relative to the lower housing portion to change the mail-storage capacity of the box.

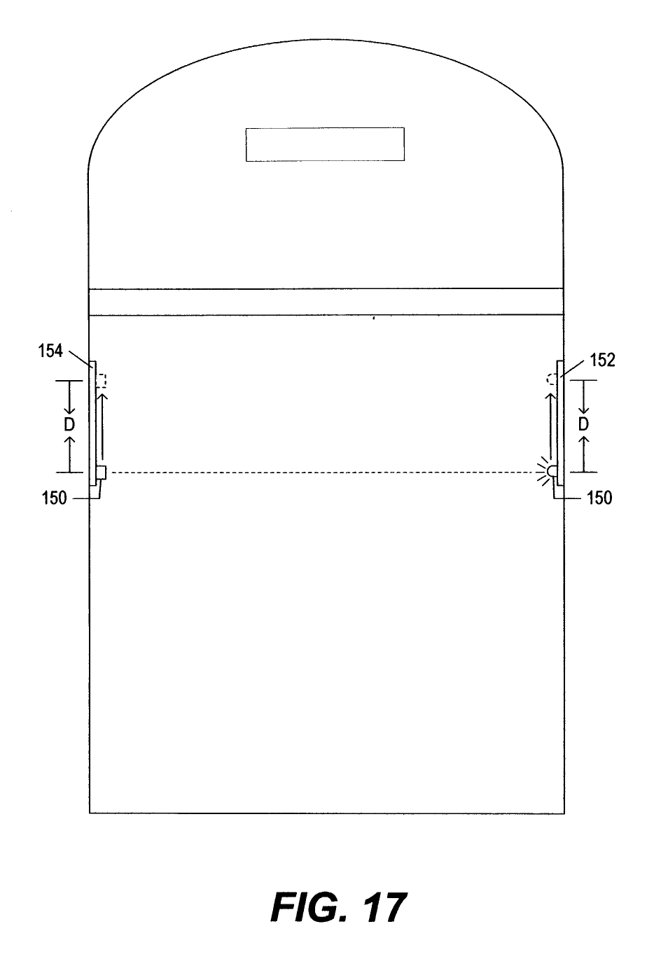

FIG. 17 shows an alternative way of changing the inner volume of a mail box of the present invention. This box includes a level sensor 150 such as previously described, however the transmitter and detector of the level sensor are placed on respective tracks 152 and 154. When the level sensor detects that the mail box is filled to capacity, the transmitter and sensor slide upwardly along the tracks by a predetermined amount D, thereby effectively increasing the inner volume of the mail box. Motors included in the box (not shown) are used to slide the transmitter and detector along their tracks. The transmitter and sensor may slide in the opposite direction, for example, in accordance with a manual button on the mail box. When pushed, the manual button may, for example, reset the transmitter and detector back to a default level. Alternatively, or in addition, the transmitter and detector may move a distance either way along tracks 152 and 154 proportional to a time a user holds an up button or down button down. These buttons may be included in any of the foregoing embodiments of the mail box of the present invention which have a variable mail-holding capacity. Guides and other stabilizing members (not shown) may be included to ensure that the transmitter and guide remain in alignment.

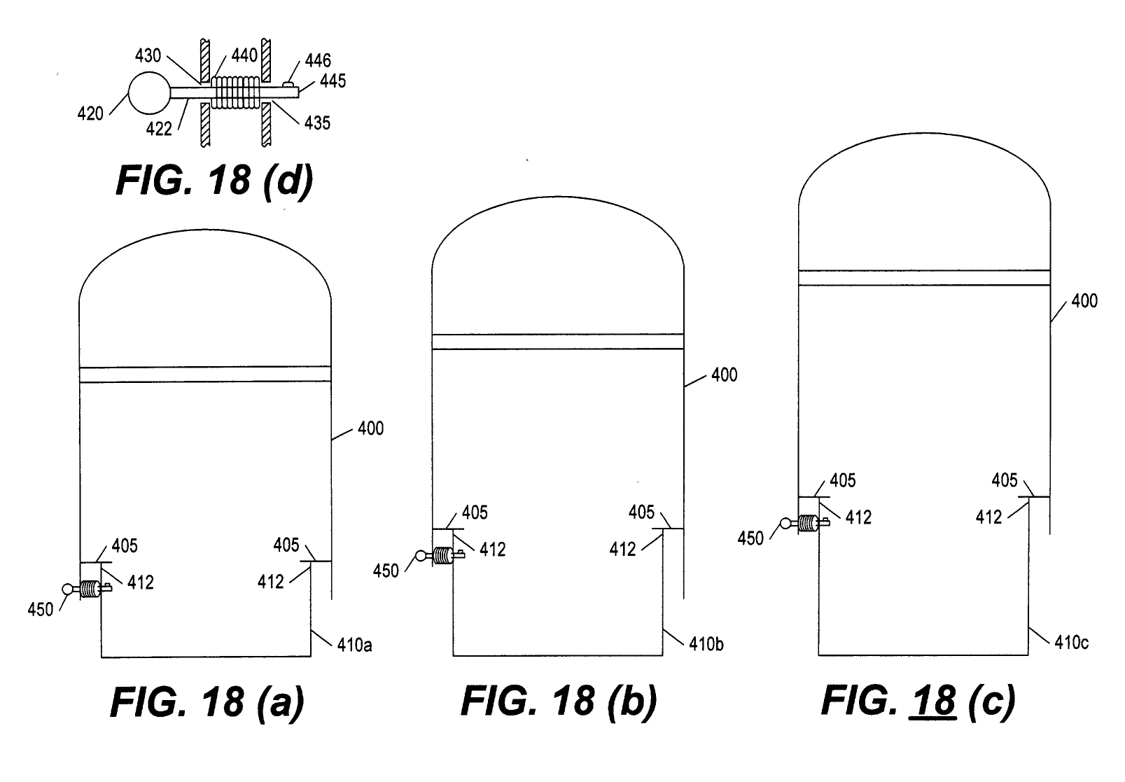

FIGS. 18(a)-18(d) show another embodiment of a mail box according to the present invention which has a variable holding capacity. This embodiment includes an upper housing portion 400 adapted for coupling to any one of a plurality lower housing portions 410a, 410b, and 410c. The coupling is performed by having the edges 412 of the lower housing portion support flanges 405 attached to and projecting from the inner surface of the upper housing portion. The lower housing portions have different sizes and are interchangeable. FIG. 18(a) shows a mail box having a small-size lower housing portion, FIG. 18(b) shows a mail box having an intermediate-size lower housing portion, and FIG. 18(c) shows a mail box having a large-size lower housing portion. This embodiment is advantageous because a user can remove the upper housing portion and replace it with a different-size lower housing portion to change the holding capacity of the mail box.

The upper housing portion may be secured to the lower housing portion in any of a variety of ways. One way includes using a locking mechanism 450 such as shown in FIG. 18(d). This mechanism includes a handle 420 attached to a support rod 422. The rod extends through a hole 430 in the upper housing and includes a spring 440 disposed between an inner surface of the upper housing portion and an outer surface of the lower housing portion. An end 445 of the support rod may include a retractable bearing 446 which deflects when inserted through a hole 435 in the lower housing portion to thereby lock the arrangement and thus the housing portions in place. The bearing holds the upper and lower housing portions together as a result of friction between the bearing and the inner surface of the lower housing portion.

The embodiments shown in FIGS. 15-18 change the capacity of the box by changing a vertical dimension. Those skilled in the art can appreciate, however, that a lateral dimension of the mail may be changed in lieu of a veritical dimension, or both vertical and lateral dimensions may be changed in order to achieve a desired capacity.

In accordance with another embodiment, the mail box of the present invention is connected to a remotely located computer system. This mail box may further include any or all of the features included in the other embodiments of the mail box described herein. With this in mind, the remote connection of the mail box may be accomplished in at least two ways.

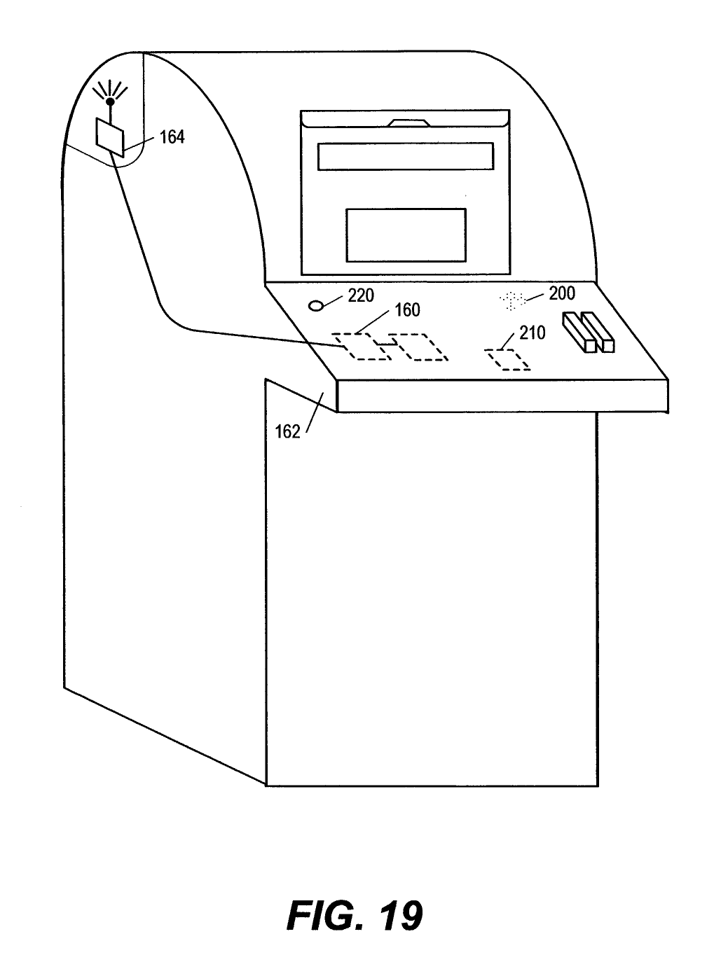

First, as shown in FIG. 19, a processor 160 in a control panel 162 of the mail box may be interfaced to a communications unit 164 which wirelessly transmits information to the remote computer system. The information may be transmitted using any type of conventional wireless communications standard. For example, if the computer system is located a relatively short distance from the box, infrared communications may be used. If the computer system is located far from the box, more sophisticated RF wireless technologies may be implemented. These technologies include but are not limited to those used by mobile phones. In fact, communications unit 164 may be constructed in a manner similar to the transmitter of a mobile phone, so that the mail box communicates information to the computer system over a wireless network such as a cellular network.

The remotely located computer system may be a personal computer, personal digital assistant, a pocket PC, a cell phone, or a more sophisticated type of terminal such as an integrated workstation. If a personal computer or workstation, the computer system is preferably linked to a database which keeps a real-time record of the status and/or performance of a plurality of mail boxes within a given service area. This information may indicate, for example, an operating condition of the box or information entered by a customer. The computer system may be programmed to provide a warning message to an operator based on this status and performance information. For example, the computer system may alert the operator that the box is filled to capacity and that access to the box has been shut down. A courier may then be dispatched to empty the box, thereby returning it to an active state.

Communications between the mail box and computer system may also be bidirectional. For example, if status information transmitted from the box indicates that a fault exists, an operator of the computer system may transmit a message to the box to instruct the processor to de-activate the box. Also, if desired, the operator may transmit instructional, advertisement, status, or other types of information for display on the control panel of the box. This way, the invention may provide real-time information to customers.

Also, the box may be interactive in nature. As previously discussed, one embodiment of the mail box of the present invention includes a customer call button. When included in this embodiment, pressing the customer call button may cause a message to be transmitted to an operator at the remotely located computer system. The operator may then communicate with the customer through a speaker (200 in FIG. 19) in the box to answer any questions the customer may have. If the computer system is located nearby, communications maybe performed via an intercom system. If located far away, communications may be performed over a mobile link, e.g., the customer and computer system operator may communicate over a cellular network just as if the customer placed a cell phone call to the operator.

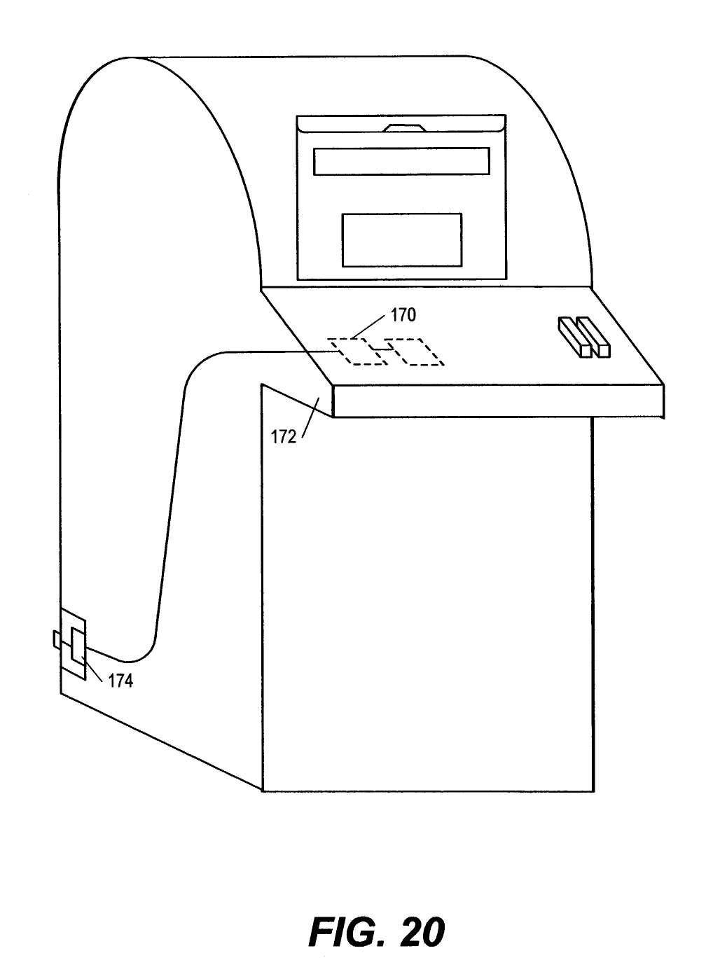

Second, as shown in FIG. 20, a processor 170 in a control panel 172 of the mail box may be interfaced to a communications unit 174 which transmits information to the computer system over a wired network connection. This wired network connection may, for example, be through the internet or over a conventional wire telephone line. (Those skilled in the art can appreciate that the internet may also be accessed through a wireless network. If desired, the invention may be configured in this manner.) All features of the invention which take place over the wireless link described above may be performed through this wired connection. Further, the remotely located computer system may receive status and performance information transmitted from the box on a website screen. These features of the invention are further described below in connection with the management system of the present invention.

At this point, it is noted that each of the features of the various embodiments of the mail box of the present invention may be combined in any order to form a custom-made box tailored to meet the requirements of customers, the computer system managing operation of the box, or both.

Also, if desired, the mail box may be equipped with multiple slots for receiving other types of mail. For example, one slot may be dedicated to receiving pre-sort mail, another slot may be used to receive regular mail, another slot for international mail, and/or other slots for special service mail. The mail may be collected within one central holding area, or the mail box may include a separate holding are for each type of mail. This embodiment is advantageous because an intermediary may collect multiple types of mail by visiting only one location.

According to another embodiment, the card reader on the control panel of the mail box reads an identification card of a customer. The processor in the control panel may then grant or deny access to customer based, for example, on whether or not the customer paid a previous bill. The bill may be a monthly bill which the customer is charged in order to use the pre-sort box or may be related to other charges. In the case where the customer is billed monthly for use of the box, the bill may be for an amount set forth in the license agreement previously discussed. If desired, access to the mail box may be free.

### Mail Processing Management System

The present invention is also a system and method which manages the status and/or performance of at least one mail box configured in accordance any of the various embodiments of the invention previously discussed. Preferably, the system and method of the invention manages a plurality of mail boxes within a given service region.

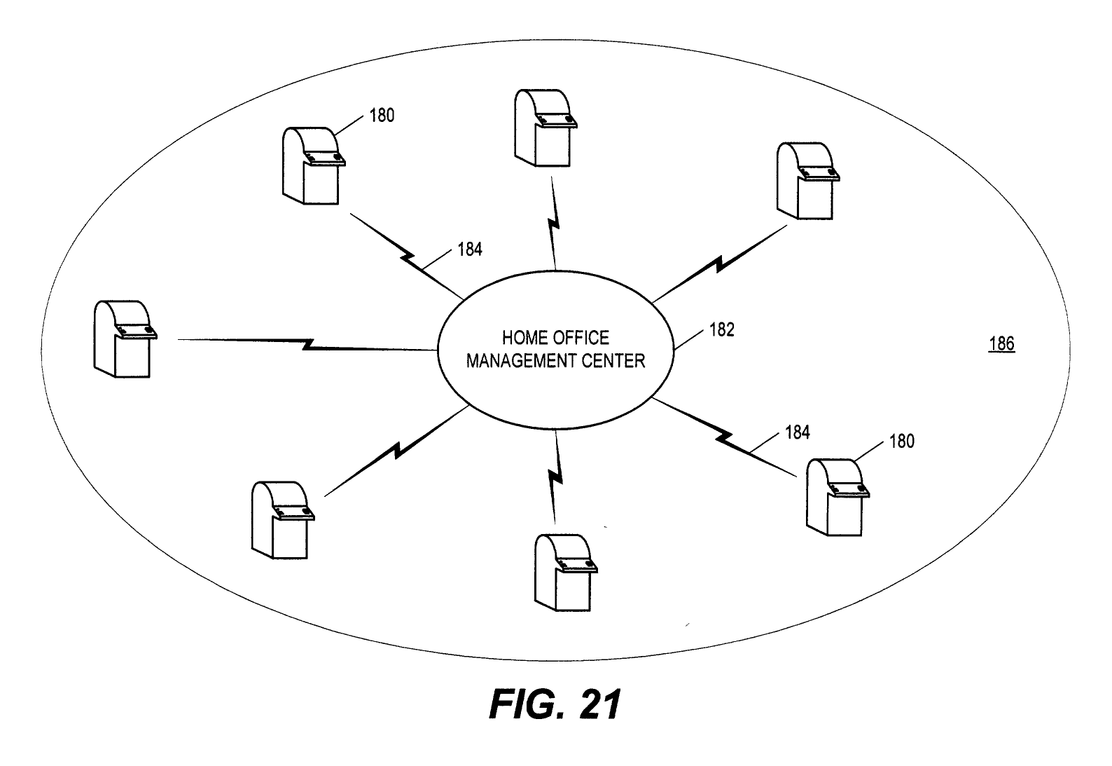

FIG. 21 shows example of how the mail processing management system of the present invention may be configured. As shown, this system may include a plurality of mail boxes 180, a home office management center 182, and a plurality of communications links 184 respectively connecting the mail boxes to the home office management center. The mail boxes are preferably configured in accordance with the present invention and are situated at different locations within a region of service 186, which, for example, may be a metropolitan area. The communications links may be wireless links, wired links, or a combination thereof. The home office management center includes a computer system of the type previously described. The computer system preferably implements a program for managing the real-time status and performance of the mail boxes within the service region.

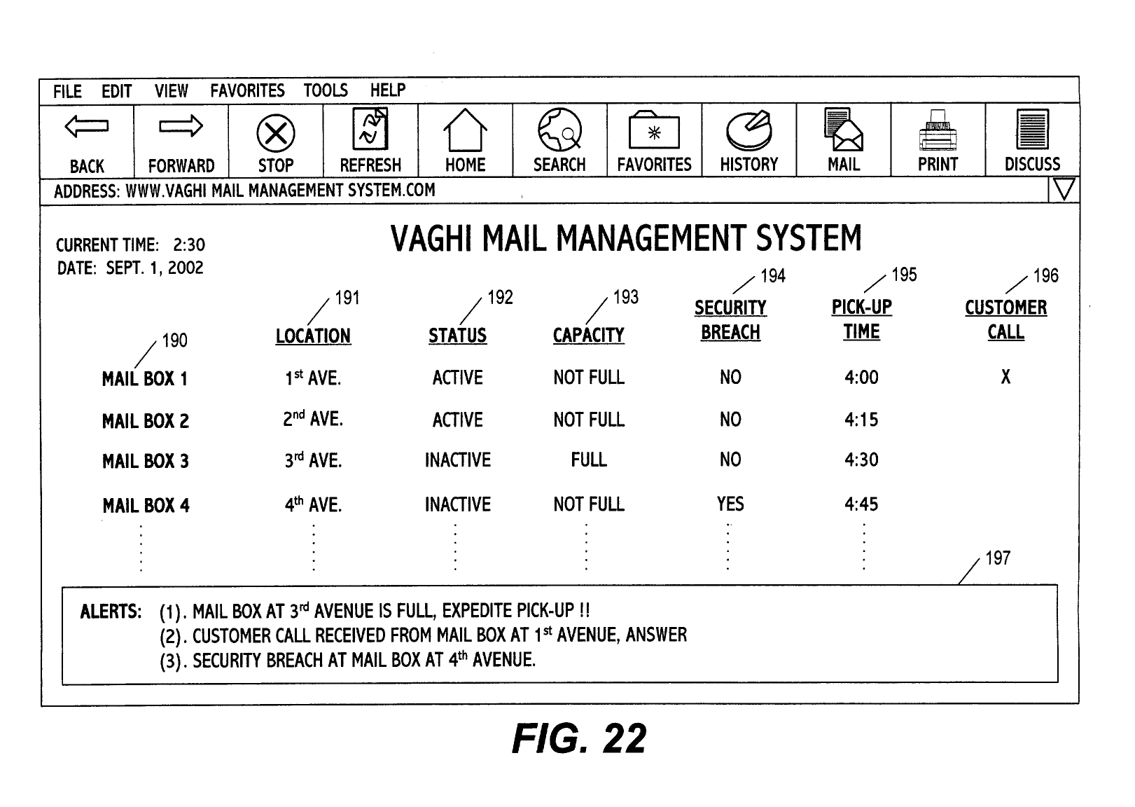

FIG. 22 shows an example of a computer screen which the system of the invention may use to monitor and manage operation of the mail boxes. The computer screen is shown as being one presented on an internet website. Under these circumstances, the program controlling the screen is preferably adapted to receive the status and performance information from the mail boxes and for automatically updating the screen to include this information. While the internet application is an especially advantageous feature of the invention, those skilled in the art can appreciate that the program used to implement the management system of the present invention may not be associated with the internet. In these circumstances, the information displayed on the computer screen may, for example, be manually entered by an operator.

The computer screen of the present invention preferably includes a list 190 of mail boxes managed by the system of the present invention along with information 191 indicating their respective locations. For each mail box, status 192, capacity 193, security 194, pick-up 195, and customer call 196 information is provided based on the data transmitted by the mail boxes. By way of example, the computer screen shows that Mail Box 1 is in the active state, that its capacity is not full, that no security breach has occurred (i.e., the mail box has not been broken into), the regularly scheduled time for picking up mail from this box is 4:00, and that a customer at this box has placed a call to an operator of the management system, for example, by pushing a customer call button on the box. The capacity of the box may be determined by the level sensor previously described, and the determination as to whether a security breach has occurred may be generated by a security sensor located at the input slot of the box.

A security sensor of this type is illustratively shown by reference numeral 210 in FIG. 19. The sensor may, for example, include detectors attached to the retractable access door protecting the input slot of the box. If this box is forced open, the detector will signal the sensor and the processor may send a corresponding signal to the management center.

The computer screen shows information for Mail Boxes 2, 3, and 4. For Mail Box 3, the computer screen indicates that the box is in an inactive state because its level sensor has indicated that it is filled to capacity. For Mail Box 4, the computer screen indicates that this box is in an inactive state because a security breach has occurred.

In addition to the foregoing features, the computer screen also preferably includes an Alerts window 197 for notifying a system operator of new developments within the system. For example, the Alerts window may alert the operator that the Mail Box at 3^{rd} Avenue is full and an expedited pick-up is required, i.e., a courier should pick-up the mail in this box before its scheduled 4:00 pick-up time.

The Alerts window also indicates that a customer call has been received from the Mail Box at 1^{st} Avenue. When this message is generated, the operator of the management system may answer the call using, for example, a telephone headset he is wearing. The telephone headset is desirable because it leaves the operator's hands free to perform other management functions within the system.

The Alerts window also indicates that a security breach has occurred for the Mail Box at 4^{th} Avenue. When this message is received, the system operator may dispatch personnel to repair the box and/or notify authorities of the breach.

The Alerts window may display other information. For example, a mail box managed within the system may be modified to include a special pick-up button (reference numeral 220 in FIG. 19). When pushed by a customer, a message is received by the system manager indicating that a special expedited pick-up request has been made at a specific location. The system manager can then dispatch a courier to pick up the mail before a certain time and that mail will be sent to the post office on the first delivery. In order to facilitate this feature of the invention, the customer may enter account information into the system using a keyboard on the control panel display of the mail box. The customer's account may then automatically be credited. Alternatively, the customer may enter identification information along with method of payment information, e.g., a credit card number. In this case, the management system of the invention may determine whether the customer is authorized to use a credit card for payment, and if not deny the customer access to the box.

The management system and method of the present invention is particularly well suited for integrating the mail box embodiments with the pre-sort method of the present invention. In this application, the mail boxes may be configured according to any one or more of the features previously described, except they are used to receive pre-sort mail only. The management system may then monitor these boxes on a periodic or real-time basis to determine the volume of mail in all the boxes in the network, preferably before the mail in these boxes is actually picked up. If the intermediary performing the pre-sort method of the invention is also the one operating the management system of the invention, the intermediary can use this information to plan ahead for the labor requirements of the day. Extremely high volume mail can be re-routed to another mail facility if the main physical site of the intermediary is unable to handle that volume. Advanced pick-ups may be initiated to reduce this volume.

If a mail box in the system is located in an office building, a display on the mail box may indicate what customers in the building have used or not used the box that day. This may be accomplished by having each customer enter a customer number or other identifying information into a memory unit preferably before placing mail into the box. The memory unit would then keep a record which could then be accessed by the courier by reading the mail box display, or this information may be transmitted back to the system manager ahead of the pick-up time. In either case, the courier may personally visit the offices of the customers in the building which have not used the box for that day in order to pick up their mail.

A number of additional features may also be included. For example, the management system of the invention may be configured to receive e-mail messages from customers. These e-mail message may, among other things, request special pick ups of mail on off- or after-business-hours times. Also, a courier while in-route may be messaged to pick up a special delivery at a customer's office. This message may be sent via pager, cell phone, or other device.

Each mail box may also be equipped with a button which a courier can push when mail is picked up. By connecting the box via a LAN, ethernet, internet, or other network to individual businesses in an office building, pushing of the button will inform the businesses that a pick up has occurred. With this feature, businesses can, for example, monitor a website to determine that a pick-up has not yet occurred, thus giving them time to go downstairs and deposit mail into the box. The mail box may also be equipped with a tracking button. When pushed by a courier, a message is sent to the system manager informing him of the current location of the courier. The mail pick-up and tracking buttons may be replaced with a smart card which a courier may slide through the card reader. The card stores information identifying the driver which is sent to the system manager. Instead of an internal memory, the box may be provided with a modem for connecting to a remote database of customer authorization codes.

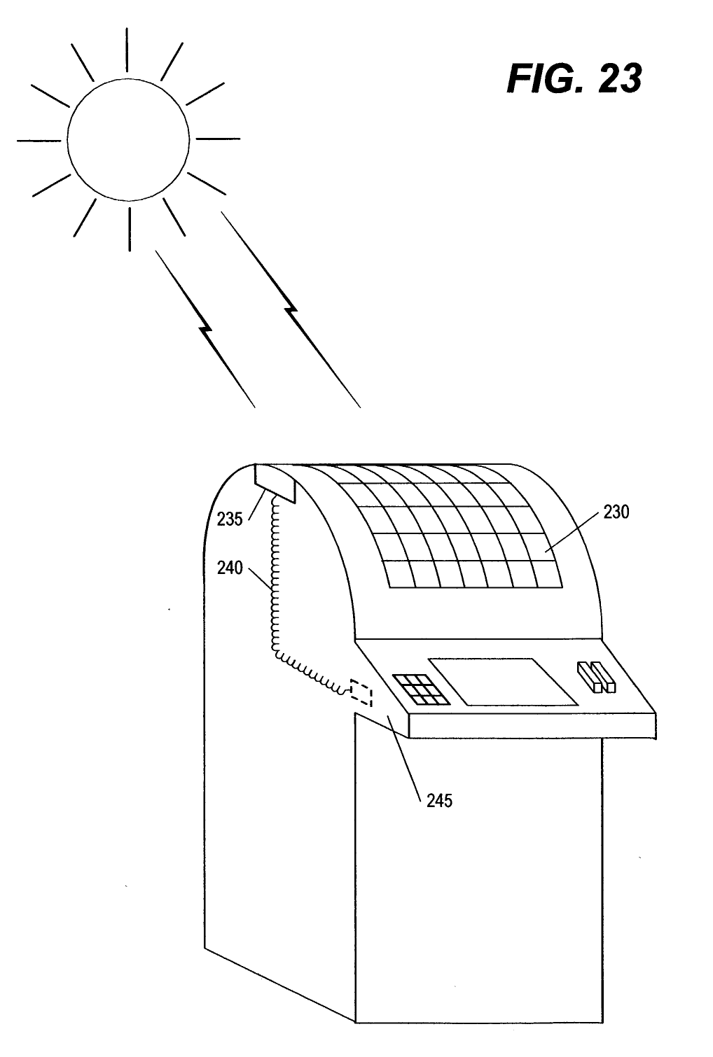

The control panel and/or any of the other features of the mail box of the present invention may be powered by a battery, may be plugged into an electrical line or may be solar powered, depending on the location of the box. FIG. 23 shows a solar-powered mail box according to the present invention, which includes a solar panel 230 equipped with a circuit 235 for converting solar energy from the sun into electrical energy, and a power line 240 for sending power to the control panel 245 and/or other features of the mail box using this electrical energy. The solar panel unit may be any type conventionally known.

Other modifications and variations to the invention will be apparent to those skilled in the art from the foregoing disclosure. Thus, while only certain embodiments of the invention have been specifically described herein, it will be apparent that numerous modifications may be made thereto without departing from the spirit and scope of the invention. For example, to assist persons of smaller stature, a step (500 in FIG. 10) may be inlucded on the mail box of the invention. This step may be fixed in a stationary position, or may be rotatably attached so that it can be moved into retracted position. Although not shown, the step may alternatively be formed as a recessed aperture in the box housing.

Also, the embodiments of the invention relating to pre-sort mail may advantageously apply to different classes or sub-classes of pre-sort mail. For example, pre-sort mail processed in accordance with the present invention may include first-class pre-sort mail, standard (regular) pre-sort mail, non-profit pre-sort mal, non-profit standard pre-sort mail, as well as any other class of pre-sort mail offered by the U.S. Postal Service.

I claim:

1. A method for processing mail, comprising:
providing a mail box for collecting pre-sort mail; and
collecting mail from the mail box.

2. The method of claim 1, wherein the providing step includes:
providing the mail box in order to collect from at least one customer a quantity of mail which is less than a minimum number required to qualify for a presort rate offered by a postal service.

3. The method of claim 2, wherein the mail box is provided within or near an area where multiple businesses are located, said at least one customer having an office in said area.

4. The method of claim 1, wherein the providing step includes:
providing the mail box to collect mail from a plurality of customers,
wherein an amount of mail deposited into the box from at least a portion of said customers is less than a minimum number required to qualify for a pre-sort rate offered by a postal service.

5. The method of claim 4, further comprising:
sorting the mail in the mail box based on geographic area; and
combining the sorted mail into bundles, wherein each bundle satisfies the minimum number required to qualify for said pre-sort rate.

6. The method of claim 4, wherein the mail box is provided within or near an area where multiple businesses are located, and wherein the portion of said customers have offices in said area.

7. A mail box, comprising:
a container for holding mail, said container including:
(a) a first housing portion, and
(b) a second housing portion; and
a connector which connects the first housing portion and the second housing portion.

8. The mail box of claim 7, further comprising:
a third housing portion having at least one dimension different from the second housing portion, said third housing portion interchangeable with the second housing portion for connection to the first housing portion.

9. The mail box of claim 7, wherein the upper housing portion is supported by the lower housing portion.

10. The mail box of claim 7, further comprising:
a lock which secures the first housing portion to the second housing portion.

11. The mail box of claim 10, wherein the lock includes:
a retractable spring-biased connector which connects the first housing portion to the second housing portion.

12. A method for processing pre-sorted mail, comprising:
receiving a collection of mail addressed to a same geographic area from each of a plurality of customers, wherein the collection of mail from each customer is less than a minimum number required to qualify for the pre-sort rate offered by a postal service;
combining the collection of mail from each customer into a bundle which includes at least the minimum number required to qualify for the pre-sort rate offered by the postal service; and
computing, for each piece of mail in the set, a profit based on a difference between a customer discount mailing rate and a pre-sort rate, said customer discount mailing rate lying between a standard mailing rate and a pre-sort rate offered by the postal service.

13. A method for processing mail, comprising:
(a) providing a mail box for receiving mail from customers who do not qualify for a pre-sort rate offered by a postal service; and
(b) arranging to collect mail from the mail box on a periodic basis.

14. A mail box, comprising:
a container for holding mail; and
a processor which performs a function related to the mail.

15. The mail box of claim 14, further comprising:
a slot for receiving the mail; and
a protector which blocks access to the slot,
wherein the processor controls the protector to allow access to the slot.

16. The mail box of claim 15, wherein the protector is a retractable door.

17. The mail box of claim 15, further comprising:
a lock,
wherein the processor controls the protector to allow access to the slot when an authorized key is input into the lock.

18. The mail box of claim 15, further comprising:
a card reader which sends a signal to the processor when said card reader reads an authorized access card, said processor removing the protector to allow access to the slot in response to said signal.

19. The mail box of claim 14, further comprising:
a display.

20. The mail box of claim 19, wherein the processor controls the display to output information related to a status of the mail box.

21. The mail box of claim 20, wherein said information indicates a fullness of mail in the container.

22. The mail box of claim 20, wherein said information indicates at least one mailing rate.

23. The mail box of claim 22, wherein the at least one mailing rate is a customer discount mailing rate for pre-sort mail.

24. The mail box of claim 19, further comprising:
a protector which blocks access to the display.

25. The mail box of claim 14, further comprising:
a scale for weighing the mail in the container.

26. The mail box of claim 25, wherein the processor outputs an indication of a fullness of the container based on a weight signal output from the scale.

27. The mail box of claim 26, wherein the processor transmits a signal through a network indicating the fullness of the container.

28. The mail box of claim 14, further comprising:
a detector which detects an amount of mail in the container.

29. The mail box of claim 28, wherein the detector detects a height of mail in the container, and wherein the processor computes the amount of mail in the container based on a signal output from the detector.

30. The mail box of claim 28, wherein the detector includes:
a transmitter; and
a detector in alignment with the transmitter,
wherein the transmitter transmits a light beam to the detector.

31. The mail box of claim 30, wherein the transmitter and detector are located at a height which corresponds to the container having a full capacity of mail.

32. The mail box of claim 14, wherein the container has a capacity which expands.

33. The mail box of claim 32, further comprising:
a housing disposed over the container;
a motor which moves the housing relative to the container; and
a detector which detects an amount of mail in the container, said processor activating the motor to move the housing relative to the container based on a signal output from the detector, said motor moving the housing to expand a mail-holding capacity of the mail box.

34. The mail box of claim 32, further comprising:
a detector which detects an amount of mail in the container; and
a motor connected to the detector,
wherein the processor activates the motor to move a position of the detector based on a signal output from the detector.

35. The mail box of claim 14, further comprising:
a communications unit connected to the processor,
wherein the communications unit transmits a signal generated from the processor or receives a signal transmitted to the mail box.

36. The mail box of claim 35, wherein the communications unit is a wireless communications unit.

37. The mail box of claim 35, wherein the communications unit transmits signals to or receives signals from a wired communications network.

38. The mail box of claim 35, wherein the communications unit is connected to the internet.

39. The mail box of claim 35, wherein the communications unit transmits at least one of status and performance information to a remote terminal.

40. The mail box of claim 35, wherein the communications unit receives information for controlling an operation of the mail box.

41. The mail box of claim 35, wherein the communications unit receives information for de-activating access to the mail box.

42. The mail box of claim 35, further comprising:
a customer call button,
wherein the processor establishes a communications link with a remote terminal when the customer call button is activated.

43. The mail box of claim 35, further comprising:
a speaker for outputting voice information transmitted to the communications unit.

44. The mail box of claim 14, further comprising:
a security unit which provides an indication that the mail box has been tampered with.

45. A method for making a mail box, comprising:
providing a container for holding mail; and
connecting a processor to the container, said processor performing a function related to mail in the container.

46. A mail processing system, comprising:
at least one mail box including a first communications unit; and
a management center including a second communications unit;
wherein the first communications unit communicates with the second communications unit.

47. The system of claim 46, wherein the first communications unit transmits at least one of status and performance information relating to the mail box to the second communications unit.

48. The system of claim 46, wherein the second communications unit transmits control information to the first communications unit.

49. The system of claim 48, wherein the control information control an operational state of the mail box.

50. A method for managing mail, comprising:
receiving information transmitted from at least one mail box; and
determining at least one of status and performance of the mail box based on the transmitted information.

51. A mail box, comprising:
an electrical part; and
a solar panel for power the electrical part.

52. The mail box of claim 51, wherein the solar panel is integrated into a housing of the mail box.

53. The mail box of claim 51, wherein the electrical part includes a processor.

54. A mail box, comprising:
a container for holding mail; and
means for changing a volume of the container.

55. The mail box of claim 54, wherein said changing means includes:
means for allowing an operator to manually change the volume of the container.

56. The mail box of claim 54, wherein the container includes:
an upper housing portion; and
a lower housing portion.

57. The mail box of claim 56, wherein said changing means includes:
a space changer which changes a position of the upper housing portion relative to the lower housing portion, or a position of the lower housing portion relative to the upper housing portion.

58. The mail box of claim 57, further comprising:
a connector which adjustably connects the upper housing portion and the lower housing portion, wherein said space changer controls the connector to change the volume of the container.

59. The mail box of claim 58, wherein said connector is a cable having a first end connected to one of the lower housing portion and the upper housing portion and a second end connected to said space changer, and
wherein said space changer changing a length of said cable to change a position of the upper housing portion relative to the lower housing portion or a position of the lower housing portion relative to the upper housing portion.

60. The mail box of claim 59, wherein said space changer applies a force to said cable to change said position, said space changer including means for allowing a user to manually operating said space changer to apply said force.

61. A mail box, comprising:
a supply of stamps; and
a port for dispensing at least one of the stamps.

62. The mail box of claim 61, further comprising:
an input device; and
a processor which dispenses at least one of the stamps based on purchase information designated by the input device.

63. The mail box of claim 62, further comprising:
a reader which reads information from a customer card relating to payment of stamps.

64. The mail box of claim 63, wherein said card is one of a smart card, a debit card, and a credit card.

65. The mail box of claim 62, further comprising:
a display.

66. A mail box, comprising:
an input device; and
a processor which receives a signal from the input device corresponding to a purchase of stamps.
